(19) United States
(12) Patent Application Publication
(10) Pub. No.: US 2017/0263129 A1
(43) Pub. Date: Sep. 14, 2017

(54) OBJECT DETECTING DEVICE, OBJECT DETECTING METHOD, AND COMPUTER PROGRAM PRODUCT

(71) Applicant: KABUSHIKI KAISHA TOSHIBA, Minato-ku (JP)

(72) Inventor: Hideo KASAMI, Yokohama (JP)

(73) Assignee: KABUSHIKI KAISHA TOSHIBA, Minato-ku (JP)

(21) Appl. No.: 15/383,054

(22) Filed: Dec. 19, 2016

(30) Foreign Application Priority Data
Mar. 9, 2016 (JP) 2016-046224

(51) Int. Cl. G08G 1/16

(52) U.S. Cl. CPC G08G 1/166; G08G 1/164; G08G 1/161

(57) ABSTRACT

An object detecting device according to an embodiment includes processing circuitry. The processing circuitry obtains identification information for identifying a position and a travel direction of a surrounding vehicle around a target vehicle, generates a two-dimensional template based on three-dimensional vehicle information corresponding to the identification information, a position and a travel direction of the target vehicle, searches for a position in two-dimensional information obtained by a sensor for surroundings of the target vehicle, when detecting a second template overlaps a first template based on a search result, calculates a ratio of overlapping portion between the first and second templates to an entire of the first template, the first template is the two-dimensional template of a first surrounding vehicle, and the second template is the two-dimensional template of a second surrounding vehicle, and outputs a notification based on the ratio, the positions and travel directions of the target and surrounding vehicles.

### CROSS-REFERENCE TO RELATED APPLICATIONS

This application is based upon and claims the benefit of priority from Japanese Patent Application No. 2016-016224, filed on Mar. 9, 2016, the entire contents of which are incorporated herein by reference.

### FIELD

Embodiments described herein relate generally to an object detecting device, an object detecting method, and computer program product.

### BACKGROUND

It has become common practice to install a camera in an automobile (i.e., a vehicle-mounted camera) and take photographs of the surroundings of the target vehicle using the vehicle-mounted camera. A technology is known in which, regarding the vehicles captured around the target vehicle by the vehicle-mounted camera, vehicle information such as vehicle positions and turn signal status is received during inter-vehicle communication, and it is determined whether or not the vehicles from which the vehicle information is received are identical to the captured vehicles.

In the past, regarding the vehicles that are present around the target vehicle but that are hidden from the target vehicle behind other vehicles or installations, due to the lack of image information, it is difficult to detect such hidden vehicles. Moreover, in the case in which the vehicle positions are estimated using the global navigation satellite system (GNSS), the estimation accuracy is about a few meters (for example, 2 meters), and sometimes it proves to be a difficult task to identify two surrounding vehicles in proximity based on the vehicle positions.

In an object detecting device according to a first embodiment, regarding the surrounding vehicles present around the target vehicle, vehicle information is obtained that contains identification information, position information, and direction information. Based on profile information in the form of three-dimensional information, position information, and direction information of the surrounding vehicles as well as based on the position information and the direction information of the target vehicle, two-dimensional information templates are generated. In the two-dimensional information about the surroundings of the target vehicle as obtained by a sensor, the positions corresponding to the two-dimensional information templates are retrieved. If it is detected that a second two-dimensional information template overlaps with the front face of a first two-dimensional information template, the ratio of the overlapping portion is calculated and a notification is output based on the ratio and, the position information and the direction information of the surrounding vehicles and the target vehicle.

### BRIEF DESCRIPTION OF THE DRAWINGS

FIG. 1 is a diagram for schematically explaining a driving support system that is applicable to embodiments;

FIG. 2 is an exemplary functional block diagram for explaining the functions of an object detecting device according to a first embodiment;

FIG. 3 is a diagram illustrating an example of surrounding-vehicle information that is applicable in the first embodiment;

FIG. 4 is a diagram illustrating an example of target-vehicle information that is applicable in the first embodiment;

FIG. 5 is a diagram illustrating an exemplary configuration of a vehicle database (DB) according to the first embodiment;

FIG. 6 is a block diagram illustrating an exemplary hardware configuration of the object detecting device that is applicable in the first embodiment;

FIG. 7 is an exemplary flowchart for explaining an object detecting operation performed according to the first embodiment;

FIG. 8A to 8G are diagrams illustrating examples of two-dimensional information template according to the first embodiment;

FIG. 9 is a diagram for schematically illustrating a search operation that is applicable in the first embodiment;

FIG. 10 is a diagram illustrating an example of performing a search operation from the front face of a two-dimensional information template according to the first embodiment;

FIG. 11 is a diagram illustrating an example of performing a search operation from the rear face of a two-dimensional information template according to the first embodiment;

FIGS. 12A and 12B are diagrams for explaining, according to the first embodiment, integration of two two-dimensional information templates whose positions are decided;

FIG. 13 is a diagram for explaining a determination operation for determining whether or not there is a possibility of a collision according to the first embodiment;

FIG. 14 is illustrated an example of a taken image obtained by an imaging processing unit;

FIG. 15A to 15G are diagrams illustrating, according to the first embodiment, examples of two-dimensional information templates generated corresponding to various vehicles;

FIGS. 16 and 17A to 17B are diagrams for explaining first example of a search operation performed according to the first embodiment;

FIGS. 18A and 18B are diagrams illustrating, according to the first embodiment, examples in which a search is performed from the rear face and from the front face of an integrated two-dimensional information template;

FIG. 19 is a schematic diagram that Thematically illustrates a state in which the positions of two-dimensional information templates in a taken image are decided according to the first embodiment;

FIG. 20 is a diagram illustrating an exemplary taken image obtained by the imaging processing unit;

FIGS. 21 and 22A to 22B are diagrams for explaining second example of a search operation performed according to the first embodiment;

FIGS. 23A and 23B are diagrams illustrating, according to the first embodiment, examples in which a search is performed from the front face and from the rear face of an integrated two-dimensional information template;

FIG. 24 is a schematic diagram that schematically illustrates, according to the first embodiment, a state in which the positions of two-dimensional information templates in a taken image are decided;

FIG. 25 is a diagram illustrating an exemplary display in response to a notification output by an output unit according to the first embodiment;

FIG. 26 is a diagram illustrating an example of a target vehicle in which two cameras are installed; and

FIG. 27 is an exemplary functional block diagram for explaining the functions of an object detecting device according to a second embodiment.

### DETAILED DESCRIPTION

According to one embodiment. According to one embodiment, an object detecting device includes processing circuitry. The processing circuitry obtains identification information for identifying a position and a travel direction of a surrounding vehicle around a target vehicle, generates a two-dimensional information template based on three-dimensional vehicle information corresponding to the identification information, a position and a travel direction of the target vehicle, searches for a position in two-dimensional information obtained by a sensor for surroundings of the target vehicle, when detecting a second template overlaps a first template based on a search result, calculates a ratio of overlapping portion between the first and second templates to an entire of the first template, the first template is the two-dimensional information template of a first surrounding vehicle, and the second template is the two-dimensional information template of a second surrounding vehicle, and outputs a notification based on the ratio, the positions and travel directions of the target and surrounding vehicles.

Exemplary embodiments of an object detecting device, an object detecting method, and a computer program product are described below.

Regarding surrounding vehicles present around the target vehicle in which the object detecting device according to the embodiments is installed, the object detecting device obtains the relationship between the target vehicle and the surrounding vehicles based on profile information in the form of three-dimensional information, state information obtained using inter-vehicle communication, and taken images that are taken by a camera installed in the target vehicle. Then, based on the relationship between the target vehicle and the surrounding vehicles, the object detecting device determines whether or not there is a possibility of a collision between the target vehicle and a surrounding vehicle and outputs notification if it is determined that there is possibility of a collision.

### System Applicable to Embodiments

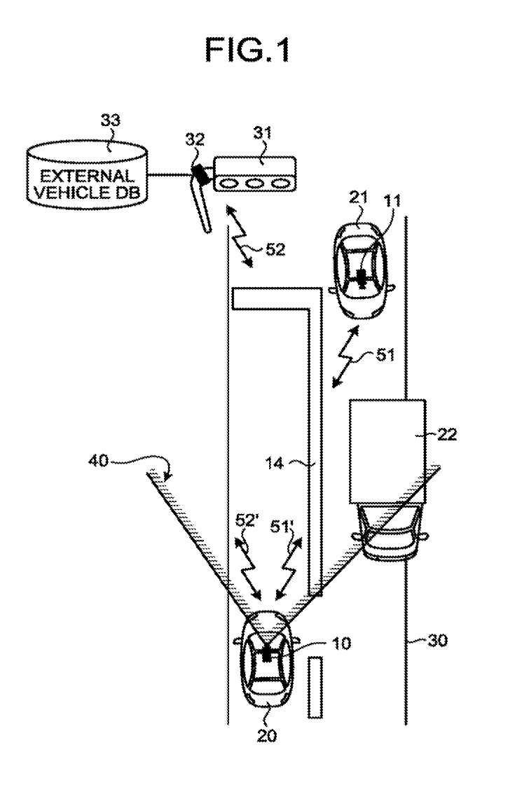

Given below with reference to FIG. 1 is schematic explanation of a driving support system that is applicable to the embodiments. In FIG. 1 is illustrated an example of an overhead view of a street 3C. In the example illustrated in FIG. 1, on the street 30 (assumed to have left-hand traffic), a vehicle 20 is present on the left-hand traffic lane of center line 14, while vehicles 21 and 22 are present on the right-hand traffic lane of the center line 14. Moreover, with reference to FIG. 1, traffic light 31 is installed at the left-hand end of the street 30.

In the vehicle 20, a vehicle-mounted apparatus 10 is installed that includes the object detecting device according to the embodiments. Although described in detail later, the object detecting device has the following functions: a communication function, a function for obtaining state information that indicates the state of the corresponding vehicle, and an imaging function for taking images using a camera. In the example illustrated in FIG. 1, it is illustrated that a camera installed in the vehicle 20 takes images within an imaging range 40. In the vehicle 21, a vehicle-mounted apparatus is installed that has a communication function and a function for obtaining state information indicating the state of the corresponding vehicle. In this example, it is assumed that the vehicle-mounted apparatus 11 that is installed in the vehicle 21 does not include the object detecting device according to the embodiments. However, that is not the only possible case. Alternatively, the vehicle-mounted apparatus 11 may include the object detecting device according to the embodiments.

In the following explanation, the vehicle 20, in which the vehicle-mounted apparatus 10 including the object detecting device according to the embodiments is installed, is referred to as the target vehicle (written as the target vehicle 20); while the vehicles and 22 present around the vehicle 20 are referred to as surrounding vehicles (written as the surrounding vehicles 21 and 22).

For example, in the surrounding vehicle 21, the vehicle-mounted apparatus 11 sends information using wireless communication 51. In the target vehicle 20, the vehicle-mounted apparatus 10 receives (using wireless communication 51′) the information that has been sent using the wireless communication 51. As a result, the vehicle-mounted apparatus 10 in the target vehicle 20 can obtain, for example, the state information that indicates the state of the surrounding vehicle 21 sent using the wireless communication 51 from the vehicle-mounted apparatus 11 in the surrounding vehicle 21. Such communication performed between vehicles is called inter-vehicle communication.

With reference to FIG. 1, a roadside device 3 that is capable of performing wireless communication with the target vehicle 20 and the surrounding vehicles 21 is installed with respect to the traffic light 31. Moreover, in the example illustrated in FIG. 1, to the roadside device 32 is connected an external vehicle database (DB) 33 in which identification information, which enables identification of each vehicle (type of vehicle), is stored in a corresponding manner with profile information in the form of three-dimensional information of that vehicle. The roadside device 32 sends information using wireless communication 52. In the target vehicle 20, for example, the vehicle-mounted apparatus 10 receives (using wireless communication 52′) the information that has been sent using the wireless communication 52. As a result, the vehicle-mounted apparatus 10 in the target vehicle 20 can obtain, for example, the identification information and the profile information, which is in the form of three-dimensional information, of vehicles as sent from the roadside device 32. Such communication performed between the roadside device 32 and a vehicle is called roadside-vehicle communication.

Given below is schematic explanation of inter-vehicle communication and roadside-vehicle communication. During inter-vehicle communication, information (such as the position, the velocity, and vehicle control information the surrounding vehicles is obtained using wireless communication between the vehicles, and driving support is provided to the driver as may be necessary. During roadside-vehicle communication, information (such as signal information, regulatory information, and street information) is obtained using wireless communication between a roadside device and infrastructure equipment, and driving support is provided to the driver as may be necessary.

Examples of the communication standard applied in inter-vehicle communication and roadside-vehicle communication include the IEEE 802.11p standard that is formulated by the Institute of Electrical and Electronics Engineers (IEEE) that uses radio waves having the frequency bandwidth of 5 GHz, and the STD-T109 standard that is formulated by the Association of Radio Industries and Businesses (ARIB) and that uses the radio waves having the frequency bandwidth of 700 MHz. The radio waves having the frequency bandwidth of 700 MHz have the communication distance of about a few hundred meters, while the radio waves having the frequency bandwidth of 5 GHz have the communication distance of a few tens of meters. In the embodiments, the radio waves having the frequency bandwidth of 5 GHz are suitable for the purpose of inter-vehicle communication performed by the surrounding vehicles 21 and 22 with the target vehicle 20.

During inter-vehicle communication, for example, for a few tens of times per second, a vehicle-mounted apparatus can send information such as state information indicating the current state of the corresponding vehicle and information indicating the position, the velocity, and the control (such as brakes). During roadside-vehicle communication, when a vehicle having a vehicle-mounted apparatus installed therein passes by a roadside device, the roadside device can send signals to the vehicle (the vehicle-mounted apparatus). Based on the information obtained using inter-vehicle communication and roadside-vehicle communication, the vehicle-mounted apparatus outputs information aimed at providing driving support.

### First Embodiment

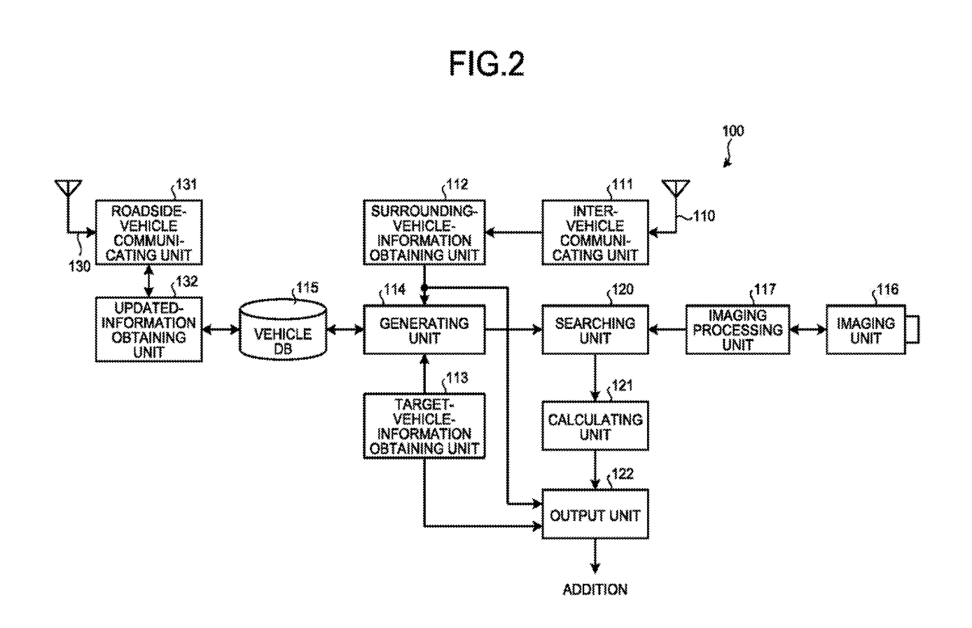

Given below is the explanation of a first embodiment. FIG. 2 is an exemplary functional block diagram for explaining the functions of an object detecting device 100 according to the first embodiment. The object detecting device 100 illustrated in FIG. 2 is included in, for example, the vehicle-mounted apparatus 0 of the target vehicle 20. With reference to FIG. 2, the object detecting device 100 includes an inter-vehicle communicating unit 111, a surrounding-vehicle-information obtaining unit 112, a target-vehicle-information obtaining unit 113, a generating unit 114, an imaging processing unit 117, a searching unit 120, a calculating unit 121, an output unit 122, a roadside-vehicle communicating unit 131, and an updated-information obtaining unit 132.

The inter-vehicle communicating unit 111, the surrounding-vehicle-information obtaining unit 112, the target-vehicle-information obtaining unit 113, the generating unit 114, the imaging processing unit 117, the searching unit 120, the calculating unit 121, the output unit 122, the roadside-vehicle communicating unit 131, and the updated-information obtaining unit 132 are implemented a central processing unit (CPU) runs computer programs. However, that is not the only possible case. Alternatively, some or all of the inter-vehicle communicating unit 111, the surrounding-vehicle-information obtaining unit 112, the target-vehicle-information obtaining unit 113, the generating unit 114, the imaging processing unit 117, the searching unit 120, the calculating unit 121, the output unit 122, the roadside-vehicle communicating unit 131, and the updated-information obtaining unit 132 can be configured using hardware circuits that operate in cooperation with each other.

With reference to FIG. 2, the inter-vehicle communicating unit 111 performs inter-vehicle communication via an antenna 110 and sends and receives information. The surrounding-vehicle-information obtaining unit 112 obtains vehicle information of the surrounding vehicles as received by the inter-vehicle communicating unit 111, and stores the obtained vehicle information for a predetermined time period (for example, one second). After the predetermined period of time elapses since obtaining the vehicle information, the surrounding-vehicle-information obtaining unit 112 destroys the vehicle information. Meanwhile, the term “surrounding” mentioned herein indicates, for example, the range within which inter-vehicle communication can be performed with the target vehicle 20.

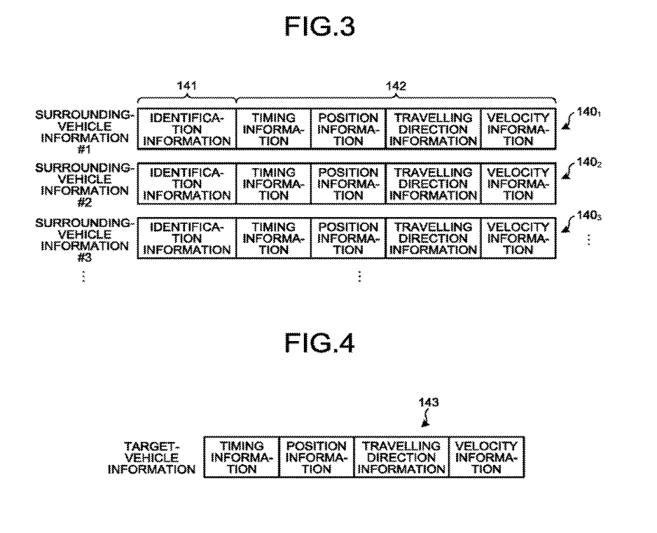

In FIG. 3 is illustrated an example of vehicle information of the surrounding vehicles (called surrounding-vehicle information) that is applicable in the first embodiment and that is obtained and stored by the surrounding-vehicle-information obtaining unit 112. As illustrated in FIG. 3, regarding a plurality of surrounding vehicles, the surrounding-vehicle-information obtaining unit 112 can obtain and store sets of surrounding-vehicle information 140₁, 140₂, 140₃, and so on. In the example illustrated in FIG. 3, the sets of surrounding-vehicle information 140₁, 140₂, 140₃, and so on are also referred to as sets of surrounding-vehicle information #1, #2, and #3, and so on.

Each of the sets of surrounding-vehicle information 140₁, 140₂, 140₃, and so on contains identification information 141 and state information 142. In the following explanation, unless particularly specified otherwise,surrounding-vehicle information 140 is explained as the representative information of the sets of surrounding-vehicle information 140₁, 140₂, 140₃, and so on.

The identification information 141 enables identification of, for example, the vehicle type of the vehicle that sent the surrounding-vehicle information 140. As far as the identification information 141 is target, it is possible to use the vehicle identification number (VIP) as defined by the International Organization for Standardization (ISO). A vehicle identification number includes a world manufacturer identifier (WMI), a vehicle description section (VDS), and a vehicle identifier section (VIS); and is expressed as a 17-digit value. Moreover, a vehicle identification number can also include type information indicating the type such as an automobile, a two-wheeled vehicle, a bicycle, a mobility scooter, a wheelchair, an electric cart, a robot, an automated guided vehicle (AGV), an unmanned aerial vehicle (UAV), a tram, a pedestrian (aged person), or a pedestrian (child).

However, the identification, information 141 is not limited to vehicle identification numbers explained above, and alternatively can be, for example, the vehicle frame numbers defined in Japan.

The state information 142 contains a variety of information indicating the state of the vehicle, which sent the surrounding vehicle information 14C, at the time of obtaining the vehicle information. In the example illustrated in FIG. 3, the state information contains timing information, position information, travelling direction information, and velocity information. The timing information indicates the timing of obtaining the vehicle information. The position information indicates the position of the vehicle at the timing specified in the timing information. The position information is specified using, for example, the latitude and the altitude. Moreover, the height can also be included in the position information. The travelling direction information indicates the orientation (the direction of travel) of the vehicle at the timing specified in the timing information. The travelling direction information can be specified using, for example, the angle with respect to the reference direction (for example, the altitude direction). The velocity information indicates the velocity of the vehicle at the timing specified in the timing information.

Regarding the variety of information specified in the state information 142, the accuracy is assumed to be as follows. For example, the timing information is assumed to have the accuracy of about ±0.1 seconds; the position information is assumed to have the accuracy of about ±2 meters for the latitude as well as for the altitude; the travelling direction information is assumed to have the accuracy of about ±20° ; and the velocity information is assumed to have the accuracy of about ±0.2 m/s.

As an example, in the case in which vehicle information is sent for 10 times in one second using inter-vehicle communication, and in which the surrounding-vehicle information 140 is destroyed by the surrounding-vehicle-information obtaining unit 112 after holding it for one second; the surrounding-vehicle information obtaining unit 112 can constantly hold 10 sets of the surrounding-vehicle information 140 in which the identification information 141 is identical but the state information 142 is mutually different.

With reference to FIG. 2, the target-vehicle-information obtaining unit 113 obtains and stores the vehicle information of the target vehicle 20 in which the object detecting device 100 is installed. In FIG. 4 is illustrated an example of target-vehicle information that is obtained and stored by the target-vehicle-information obtaining unit 113. With reference to FIG. 4, target-vehicle information 143 contains timing information, position information, travelling direction information, and velocity information. Herein, the above-mentioned types of information have the same meaning as the timing information, the position information, the travelling direction information, and the velocity information specified in the state information 142 explained earlier.

The target-vehicle-information obtaining unit 113 can obtain the position information using the global navigation satellite system (GNSS), or can estimate the position information based on the travelling direction information and the velocity information. Moreover, the target-vehicle information obtaining unit 113 obtains and stores the target-vehicle information 143 in a repeated manner at predetermined intervals (for example, 10 times/second), and destroys the stored target-vehicle information 143 after the elapse of predetermined period of time (for example, one second) since obtaining the target-vehicle information 143.

A vehicle DB 115 stores the identification information 141 in a corresponding manner with the profile information in the form of three-dimensional information of the vehicles specified in the identification information 141. For example, when the identification information 141 is input, the vehicle DB 115 outputs the profile information corresponding to the input identification information 141. In the following explanation, profile information in the form of three-dimensional information is abbreviated as 3D profile information.

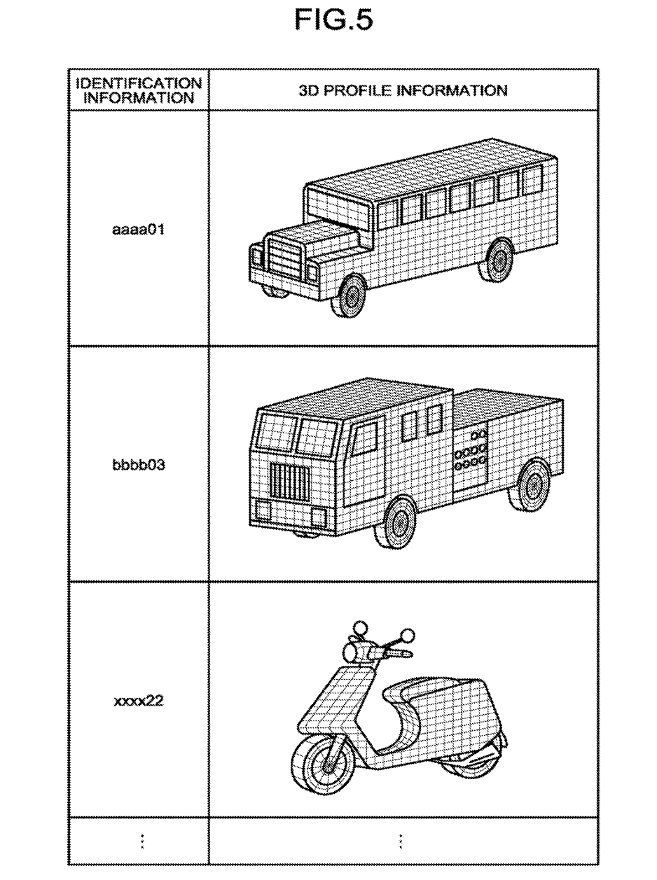

In FIG. 5 is illustrated an exemplary configuration of the vehicle DR 115 according to the first embodiment. The vehicle DB 115 stores the identification information 141 and the 3D profile information associated with one-to-one correspondence. In FIG. 5, for convenience sake, the identification information 141 is expressed as 6-digit values “aaaa01”, “bbbb03”, and “xxxx22”.

The 3D profile information represents information in which the profile of a vehicle is expressed using three-dimensional information such as the coordinates (x, y, each apex in the profile of the vehicle with respect to a predetermined origin and information indicating lines joining the apices. However, that is not the only possible case. Alternatively, the 3D profile information can also contain information indicating the faces surrounded by three or more apices. For example, the 3D profile information is provided by the vehicle manufacturers based on the computer-aided design (CD) data at the time of designing.

Since the 3D profile information has the three-dimensional coordinate information, if a rotation matrix having the desired angle of rotation is applied to the 3D profile information so that the 3D profile information is rotated and projected onto a two-dimensional plane, then a two-dimensional-information-based profile view of the vehicle viewed from the desired orientation can be created with ease. In an identical manner, if a scaling matrix having the desired scaling ratio is applied to the 3D profile information so that the 3D profile information is scaled and projected onto a two-dimensional plane, then a two-dimensional-information-based profile view of the vehicle scaled to the desired size can be created with ease.

Meanwhile, it is desirable that the vehicle DB 115 holds the 3D profile information at, for example, at least the accuracy of pixels in the image recognition performed by the searching unit 120 described later. Moreover, the 32 profile information can be set to have finer accuracy too. However, the finer the accuracy is, the greater becomes the data volume and the longer becomes the processing time. For that reason, it is desirable that the accuracy of the 3D profile information, which is stored in the vehicle DB 115, is decided by taking into account the required accuracy, the required processing speed, and the manageable data volume.

With reference to FIG. 2, the generating unit 114 generates two-dimensional information templates corresponding to the sets of surrounding-vehicle information 140₁, 140₂, 140₃, and so on based on the following information: the sets of surrounding-vehicle information 140₁, 140₂, 140₃, and so on obtained by the surrounding-vehicle-information obtaining unit 112; the target-vehicle information 143 obtained by the target-vehicle-information obtaining unit 113; and the 3D profile information stored in the vehicle DB 115.

The generating unit 114 obtains, from the vehicle DB 115, the 3D profile information corresponding to, for example, the identification information specified in the surrounding-vehicle information 140. Based on the state information 142 and the target-vehicle information 143 specified in the surrounding-vehicle information 140, the generating unit 114 obtains the relative positions and the travelling directions of the surrounding vehicles, which are specified in the surrounding-vehicle information 140, when viewed from the target vehicle 20. Then, based on the relative positions and the travelling directions, the generating unit 114 applies rotation and scaling with respect to the 3D profile information obtained from the vehicle DB 115; projects the post-rotation and post-scaling 3D profile information onto a two-dimensional plane; and generates two-dimensional information. This two-dimensional information, which is generated by applying rotation and scaling with respect to the 3D profile information based on the relative position and the travelling direction when viewed from the target vehicle 20 and then projecting the 3D profile information onto a two-dimensional plane, is called a two-dimensional information template. Regarding the operations performed by the generating unit 114 to generate a two-dimensional information template, the detailed explanation is given later.

An imaging unit 116 is, for example, a vehicle-mounted camera installed in the target vehicle 20. For example, the vehicle-mounted camera takes an image of a predetermined imaging range on the front side of the target vehicle 20 and outputs the taken image. The imaging processing unit 117 controls the imaging performed by the imaging unit 116; performs predetermined image processing such as noise removal and level adjustment with respect to the taken image output by the imaging unit 116; and outputs the post-image-processing taken image.

The searching unit 120 performs image matching with respect to the taken image, which is output by the imaging processing unit 117, using the two-dimensional information templates generated by the generating unit 114 and obtains such positions in the taken image which correspond to the two-dimensional information templates. At that time, the searching unit 120 detects whether or not there exists a second two-dimensional information template that overlaps with the front face of a first two-dimensional information template.

When the searching unit 120 detects that there exists a second two-dimensional information template which overlaps with the front face of a first two-dimensional information template, the calculating unit 121 calculates the ratio of such a portion in the first two-dimensional information template which is overlapped by the second two-dimensional information template and the entire first two-dimensional information template. Then, the calculating unit 121 performs threshold value determination with respect to the calculated ratio and, if the ratio is equal to or greater than the threshold value, sends information indicating the first two-dimensional information template to the output unit 122.

The output unit 122 obtains, from the surrounding-vehicle-information obtaining unit 112, the state information 142 that is associated to the identification information 141 corresponding to the information indicating the two-dimensional information template sent by the calculating unit 121. Moreover, the output unit 122 obtains the target-vehicle information 143 from the target-vehicle-information obtaining unit 113. Then, based on the state information 142 and the target-vehicle information 143, the output unit 122 determines whether or not there is a possibility of a collision between surrounding vehicle 21, which corresponds to the two-dimensional information template sent by the calculating unit 121, and the target vehicle 20. If it is determined that there is a possibility of a collision, then the output unit 122 outputs a notification about a possibility of a collision.

With reference to FIG. 2, the roadside-vehicle communicating unit 131 sends and receives information via an antenna 130 using roadside-vehicle communication. The updated-information obtaining unit 132 performs roadside-vehicle communication with the roadside device 32 using the roadside-vehicle communicating unit 131 and checks the external vehicle DB 33, which is connected to the roadside device 32, about the presence or absence of updated 3D profile information. As a result of the inquiry, if the external vehicle DB 33 is found to have been updated, the updated-information obtaining unit 132 obtains the updated profile information from the external vehicle DB 33 and updates the 3D profile information stored in the vehicle DB 115 with the obtained 3D profile information.

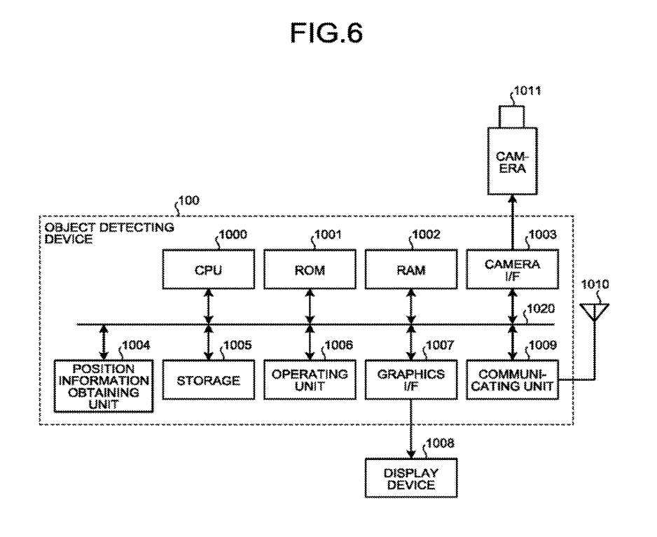

In FIG. 6 is illustrated an exemplary hardware configuration of the object detecting device 100 implementable in the first embodiment. With reference to FIG. 6, the object detecting device 100 includes a CPU 1200, a read only memory (ROM) 1001, a random access memory (R 1002, a camera I/F 1003, a position information obtaining unit 1004, a storage 1002, an operating unit 1006, a graphics I/F 1007, and a communicating unit 1009. Moreover, these constituent elements are communicably connected to one another by a bus 1020.

The storage 1005 is a memory medium for storing data in a nonvolatile manner, and it is possible to use a flash memory or a hard disk drive. The CPU 1000 follows the computer programs stored in advance in the storage 1005 or the ROM 1001, uses the RAM 002 as the work memory, and controls the operations of the object detecting device 100.

The surrounding-vehicle-information obtaining unit 11 and the target-vehicle-information obtaining unit 113 store the sets of surrounding-vehicle information and the target-vehicle information 143, respectively, in the storage 1005. However, that is not the only possible case. Alternatively, the surrounding-vehicle-information obtaining unit 112 and a target-vehicle-information obtaining unit 113 can store the sets of surrounding-vehicle information and the target-vehicle information 143, respectively, in the RAM 1002. Meanwhile, the information of the vehicle DB 115 is stored in the storage 1005.

The camera I/F 1003 is an interface for connecting a camera 1011, which functions as a sensor for detecting the surrounding state of the target vehicle 20, with the object detecting device 100. The imaging unit 116 illustrated in FIG. 2 corresponds to, for example, a configuration including the camera 1011 and the camera I/F 1003. The CPU 1000 can control the imaging operation of the camera 1011 via the camera I/F 1003.

The position information obtaining unit 1004 obtains information indicating the current position using, for example, the global navigation satellite system (GNSS). However, that is not the only possible case. Alternatively, the position information obtaining unit 1004 can obtain the current position using an inertial measurement unit (IMU), or can obtain the current position using the GNSS and an IMU in combination. Still alternatively, the position information obtaining unit 1004 can calculate the current position based on the velocity of the target vehicle 20 and the angle of the steering wheel.

The operating unit 1006 receives user operations from an operation console or a touch-sensitive panel. The graphics I/F 1007 converts display data, which is generated by the CPU 1000 according to the computer programs, into display control signals that can drive a display device 1006 and outputs the display control signals. In the display device 1008, for example, a liquid crystal display (LCD) is used as the display on which screens are displayed according to the display control signals sent from the graphics I/F 1007.

The communicating unit 1009 performs wireless communication via an antenna 1010. In the example illustrated in FIG. 6, the communicating unit 1009 has the function of the inter-vehicle communicating unit 111 and the roadside-vehicle communicating unit 131 illustrated in FIG. 2. Moreover, the antenna 1010 has the function of the antenna 110 and the function of the antenna 130 illustrated in FIG. 2. However, that is not the only possible case. Alternatively, two antennas corresponding to the antennas 110 and 130 illustrated in FIG. 2 can be installed, and a communicating unit for implementing the function of the inter-vehicle communicating unit 111 can be installed along with another communicating unit for implementing the function of the roadside-vehicle communicating unit 131.

Meanwhile, an object detecting program for performing the object detecting operation according to the first embodiment is provided by being recorded as an installable file or an executable file in a computer-readable recording medium suck as a compact disk (CD) or a digital versatile disk (DVD). However, that is not the only possible case. Alternatively, the object detecting program can be provided by being stored in advance in the ROM 1001.

Still alternatively, the object detecting program for performing the object detecting operation according to the first embodiment can be,stored in a downloadable manner in a computer connected to a communication network such as the Internet. Still alternatively, the object detecting program for performing the object detecting operation according to the first embodiment can be provided or distributed via a communication network such as the Internet.

The object detecting program for performing the object detecting operation according to the first embodiment contains modules for the constituent elements explained above (i.e., the inter-vehicle communicating unit 111, the surrounding-vehicle-information obtaining unit 112, the target-vehicle-information obtaining unit 113, the generating unit 114, the imaging processing unit 117, the searching unit 120, the calculating unit 121, the output unit 122, the roadside-vehicle communicating unit 131, and the updated-information obtaining unit 132). As far as the actual hardware is target, the CPU 1002 reads the object detecting program from, for example, the storage 1005 and executes it so that the constituent elements are loaded and generated in a main memory device)such as the RAM 1002).

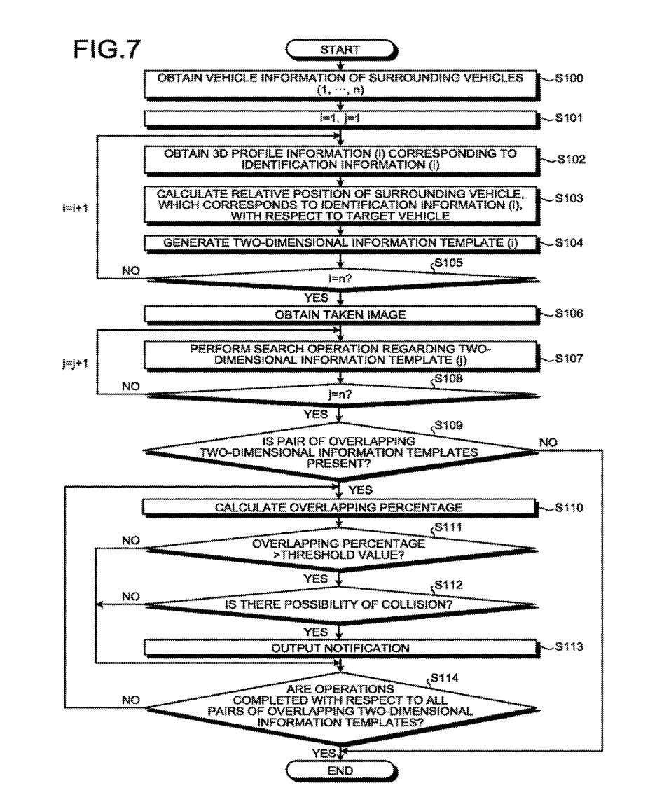

Explained below in detail with reference to FIGS. 7 to 13 is the object detecting operation performed by the object detecting device 100 according to the first embodiment. FIG. 7 is an exemplary flowchart for explaining the object detecting operation performed by the object detecting device 100 according to the first embodiment.

At Step S100, the surrounding-vehicle-information obtaining unit 112 makes use of the inter-vehicle communication performed by the inter-vehicle communicating unit 111 and obtains the surrounding-vehicle information 140 about the surrounding vehicle 21 that is present around the target vehicle 20. Herein, it is assumed that the surrounding-vehicle information 140 is obtained for n number of surrounding vehicles 21. Then, at Step S101, variables i and j that are used in the subsequent operations are initialized to 1.

At Step S102 performed next, the generating unit 114 receives n number of sets of surrounding-vehicle information 140 that are obtained at Step S100, and retrieves the identification information 141 from each set of surrounding-vehicle information 140. If a plurality of sets of surrounding-vehicle information 140 contain the identical identification information 141, then the generating unit 114 obtains the latest surrounding-vehicle information 140 based on the timing information specified in those sets of surrounding-vehicle information 140.

At Steps S102 to S105, each set of identification information 141 is expressed as identification information (i) using the variable i (where i is an integer satisfying 1≦i≦n). The generating unit 114 obtains 3D profile information (i) corresponding to the identification information (i) from the vehicle DB 115.

At Step S103 performed next, the generating unit 114 obtains the target-vehicle information 143 from the target-vehicle information obtaining unit 113. In that case too, in an identical manner to the case of the surrounding-vehicle information 140, if a plurality of sets of target-vehicle information 143 is stored in the target-vehicle information obtaining unit 113, the generating unit 114 obtains the latest target-vehicle information 143 based on the timing information.

Based on the target-vehicle information 143 that is obtained and the state information 142 that is specified in the identification information (i), the generating unit 114 calculates the relative position of the surrounding vehicle 21, which corresponds to the identification information (i), with respect to the target vehicle 20. For example, the generating unit 114 calculates the relative position based on the position information, the travelling direction information, and the velocity information specified in the target-vehicle information 143 as well as based on the position information, the travelling direction information, and the velocity information specified in the state information 142 corresponding to the identification information (i).

At Step S104 performed next, based on the relative position calculated at Step S103, the generating unit 114 projects the 3D profile information corresponding to the identification information (i) onto a two-dimensional plane and generates a two-dimensional information template (i) based on that 3D profile information. Herein, the two-dimensional plane onto which the 3D profile information is projected is assumed to be a two-dimensional plane corresponding to the imaging range (the angle of view) of the imaging unit 116 (the camera 1011). Thus, the image information obtained by the imaging unit 116 is two-dimensional information.

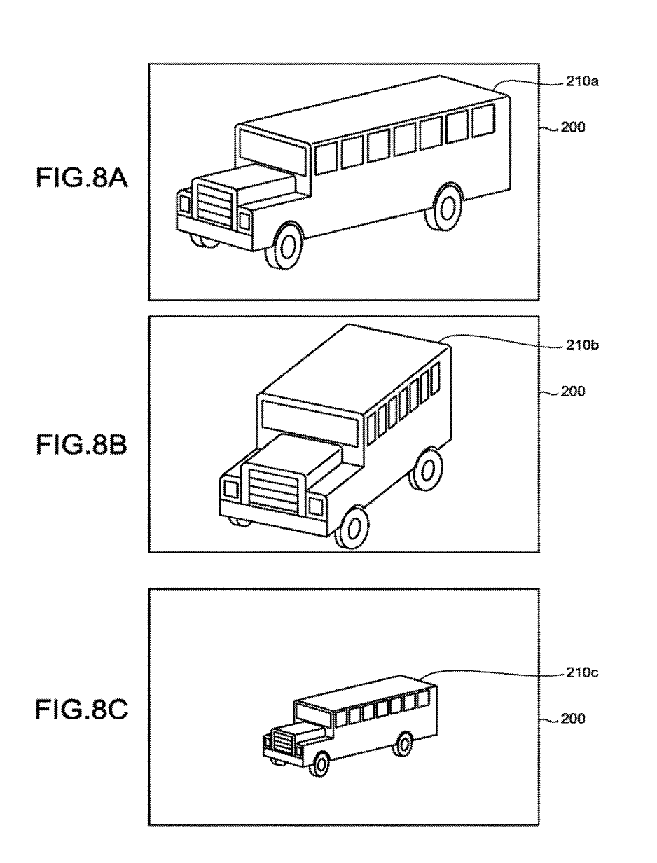

In FIG. 8A to 8C are illustrated examples of the two-dimensional information template (i) that is generated by the generating unit 114 at Step S104. In FIG. 8A to FIG. 8C are illustrated two-dimensional information templates 210a to 210c that are generated from the same 3D profile information and that have mutually different orientations and sires. Herein, in FIG. 8A to FIG. 8C, in order to make the sizes and the orientations of the two-dimensional information templates 210a to 210c comparable, for convenience sake, the two-dimensional information templates 210a to 210c are arranged within a taken image 200 that is taken by the imaging unit 116.

Moreover, in FIG. 8A to FIG. 8C, the two-dimensional information templates 210a to 210c are generated based on the 3D profile information corresponding to the identification information “aaaa01” illustrated in FIG. 5, and the details of each two-dimensional information template are illustrated in a simplified form.

In FIG. 8A and FIG. 8C are illustrated examples of the two-dimensional information templates 210a and 210b in the case in which the same surrounding vehicle 21 has the same relative position with respect to the target vehicle 20 but has different relative travelling directions. In FIG. 8C is illustrated an example of the two-dimensional information template 210c in the case in which the abovementioned surrounding vehicle 21 is positioned farther than the position thereof illustrated in FIG. 8A with respect to the target vehicle 20.

With respect to the 3D profile information corresponding to the identification information 141 of the surrounding vehicle 21 of interest, the generating unit 114 performs scaling and rotation based on, for example, the position information and the travelling direction information of the target vehicle 20 and the surrounding vehicle 21 of interest; and generates post-conversion 3D profile information. Then, the generating unit 114 projects the post-conversion 3D profile information onto a two-dimensional plane, and generates the two-dimensional information templates 210a to 210c.

In this way, the generating unit 114 generates two-dimensional information templates from the 3D profile information. For that reason, the generating unit 114 can generate image (the two-dimensional information templates 210a and 210b) that are oriented according to the relative travelling directions with respect to the target vehicle 2C. In an identical manner, the generating unit 114 can generate an image (the two-dimensional information template 210c) that is positioned farther than the target vehicle 20 and that appears smaller than the target vehicle 2C.

Returning to the explanation with reference to FIG. 7, at Step S135 performed next, the generating unit 114 compares the variable i with the value n, and determines whether or not the n number of sets of surrounding-vehicle information 140 obtained at Step S100 have been processed. If it is determined that the n number of sets of surrounding-vehicle information 140 are not yet processed (No at Step S105), then the generating unit 114 increments the variable i by one (i=i+1), and the system control returns to Step S102. If it is determined that the n number of sets of surrounding-vehicle information 140 are processed (Yes at Step 105), the system control proceeds to Step S106. At that time, the generating unit 114 sends the n number of two-dimensional information templates (1) to (n), which are generated as a result of the operations performed at Steps S102 to S104, to the searching unit 120.

At Step S106 performed next, the imaging processing unit 117 obtains the taken image output from the imaging unit 116, and sends that taken image to the searching unit 120. As long as the operation of obtaining the taken image is performed before the operation at Step 107 performed next, there no restriction on the timing of obtaining the taken image. For example, the taken image can be obtained at the time of obtaining the surrounding-vehicle information 140 at Step S100, or the taken image can be obtained immediately before or immediately after obtaining the surrounding-vehicle information 140 at Step S100.

At Steps S107 and S108 performed next, the searching unit 120 treats each of the two-dimensional information templates (1) to (n), which are sent by the generating unit 114, as the search target and performs a search operation in the taken image 200 sent by the imaging processing unit 117. Herein at Steps S107 and S108, each set of identification information 141 is expressed as identification information (j) using the variable j (where j is an integer satisfying 1≦j≦n).

At Step S107, the searching unit 120 performs a search operation regarding the two-dimensional information template (j) from among the two-dimensional information templates (1) to (n). When an image corresponding to the two-dimensional information template (j) is retrieved from the taken image 200, the searching unit 120 associates the identification information (j), which corresponds to the two-dimensional information template (j), to the position or the area from which the image is received.

At Step S108 performed next, the searching unit 120 compares the variable 1 with the value n, and determines whether or not the operations are completed regarding the two-dimensional information templates (1) to (n) sent by the generating unit 114. If it is determined that the operations are not yet completed (No at Step S108), then the searching unit 120 increments the variable j by one (j=j+1), and the system control returns to Step S107. If it is determined that the operations are completed (Yes at Step 108), the system control proceeds to Step S109.

Herein, it is desirable that the searching unit 120 performs the searching operation at Step S107 in order from the two-dimensional information tern plate having the largest sire from among the two-dimensional information templates (1) to (n). In this case, the size points to, for example, the dimensions of the two-dimensional information template. However, that is not the only possible case. Alternatively, the size can be set as the size of the two-dimensional information template in the horizontal direction or the vertical direction within the taken image 200.

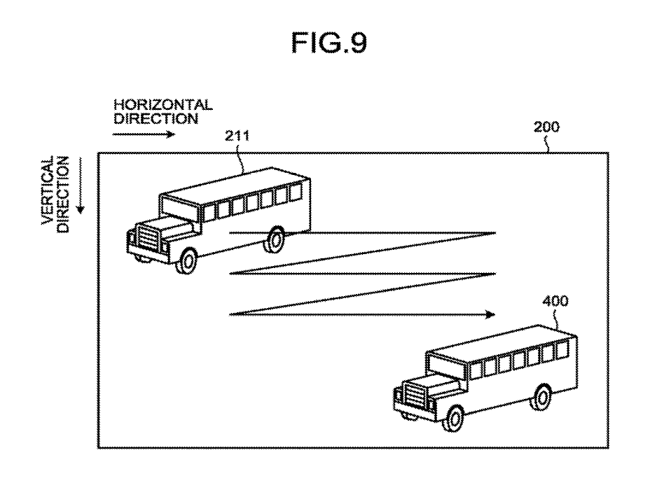

Explained below in detail with reference to FIGS. 9 to 12 is the search operation according to the first embodiment. In FIG. 9 is schematically illustrated a search operation that can be implemented in the first embodiment. As illustrated in FIG. 9, the searching unit 120 moves a two-dimensional information template 211, which is the search target, within the taken image 200 in which the search is to be performed. For example, the searching unit 120 moves the two-dimensional information template 211 in predetermined units in the horizontal direction within the taken image 200, and further moves the two-dimensional information template 211 in predetermined units in the vertical direction within the taken image 200. At each position to which the two-dimensional information template 211 is moved, the searching unit 120 calculates the degree of similarity between the two-dimensional information template 211 and an image 400 of the area corresponding to the two-dimensional information template in the taken image. Herein, the degree of similarity can be calculated by implementing an existing technology such as the sum of squared difference (SSD) or the sum of absolute difference (SAD). However, that is not t only possible case, and the degree of similarity can be calculated with respect to, for example, the edge detection result of images.

In the taken image 200, the second surrounding vehicle 21 that is positioned behind the first surrounding vehicle 21 when viewed from the target vehicle 20 gets partially or entirely hidden due to the image of the first surrounding vehicle 21. Hence, the second surrounding vehicle 21 does not get included, partially or entirely, in the taken image 200. On the other hand, in the surrounding-vehicle information 140, the state information 142 contains the position information. Hence, based on the surrounding-vehicle information 140, it becomes possible to recognize the second surrounding vehicle 21 that is not captured in the taken image 200 but that is present around the target vehicle 20. However, as described earlier, the position information specified in the state information 142 has a comparatively greater accuracy of ± few meters. Thus, in the determination performed using only the position information, there is a risk of misidentifying the positional relationship (anteroposterior relationship) between the first surrounding vehicle 21 and the second surrounding vehicle 21 when viewed from the target vehicle 20.

For that reason, regarding the search operation to be performed after the position of the initial two-dimensional information template is decided in the taken image 200, it is desirable that the searching unit 120 performs the search operation from the front face as well as from the rear face of the two-dimensional information template whose position has been already decided before the search operation.

The front face of a two-dimensional information template represents the face thereof when viewed from the target vehicle 20. On the other hand, the rear face of a two-dimensional information template represents the face thereof when viewed in the direction of locking at the target vehicle 20 from that two-dimensional information template. In other words, in a two-dimensional information template, the face visible from the target vehicle 20 represents the front face, while the face not visible from the target vehicle 20 represents the rear face.

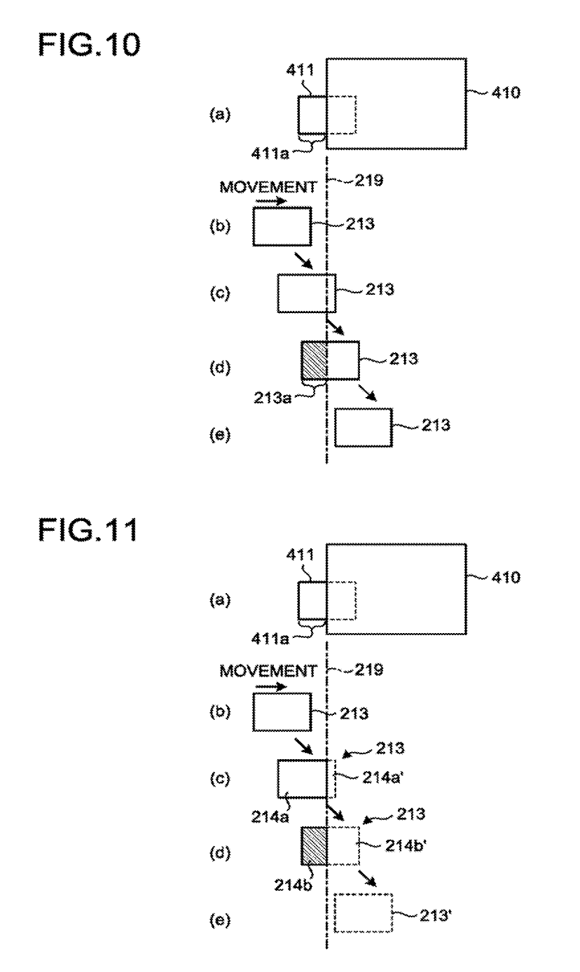

Explained below with reference to FIGS. 10 and 11 is the search operation (a first search) performed by the searching unit 120 from the front face of a two-dimensional information template and the search operation (a second search) performed by the searching unit 120 from the rear face of the two-dimensional information template. In FIGS. 10 and 11 are illustrated examples in which, in the state in which the position of the two-dimensional information template corresponding to an image 410 is already defined, the search operation is performed with respect to a two-dimensional information template 213 corresponding to an image 411.

As illustrated in (a) in FIG. 10 and (a) in FIG. 11, as the position in the taken image, some portion of the two-dimensional information template 213 is assumed to be overlapping with the two-dimensional information template whose position is already decided. Moreover, of the image 411 corresponding to the two-dimensional information template 213, an image 411a of the portion other than the overlapping portion with the image 410 is appearing in the taken image. Herein, it is assumed that the image 411a represents 40% of the entire image 411.

In the following explanation, the degree of similarity is expressed as a degree of similarity S that satisfies and the degree of similarity S=1 represents the highest degree of similarity.

In FIG. 10 is illustrated an example of performing the search operation from the front face of a two-dimensional information template. In this case, as illustrated in (b) in FIG. 10 to (e) in FIG. 10, the searching unit 120 ignores the two-dimensional information template which corresponds to the image 410 and whose position is already decided, and performs d search with respect to the two-dimensional information template 213 corresponding to the image 411. Meanwhile, in (b) in FIG. 10 to (e) in FIG. 10, a boundary line 219 represents the boundary, on the side of the image 411, of the two-dimensional information template corresponding to the image 410.

During the search operation, as explained with reference to FIG. 9, the searching unit 120 moves the two-dimensional information template 213, which is the search target, in the horizontal direction within the taken image in which the search is to be performed. In (b) in FIG. 10 to (e) in FIG. 10 is illustrated the case in which the searching unit 120 sequentially moves the two-dimensional information template 213 in the right-hand direction. In the state in which the two-dimensional information template 213 has moved to the position illustrated in (d) in FIG. 10 at which left-hand portion 213a of the two-dimensional information template 213 substantially matches with the image 411a, the degree of similarity S becomes the highest. In that case, since some portion of the two-dimensional information template 213 is similar to the image 411a, the degree of similarity S is assumed to be equal to 0.4 according to, for example, the ratio of the image 411a with respect to the entire image 411.

In FIG. 11 is illustrated an example of performing the search operation from the rear face of a two-dimensional information template. In (a) in FIG. 11 to (e) in FIG. 11 is illustrated an example in which the two-dimensional information template 213 is moved to the positions corresponding to positions illustrated in (a) in FIG. 10 to (e) in FIG. 10. In this case, as illustrated in (b) in FIG. 11 to (e) in FIG. 11, the searching unit 120 performs a search using the difference between the two-dimensional information template which corresponds to the image 410 and whose position is already decided and the two-dimensional information template 213 corresponding to the image 411.

In an identical manner to the earlier example, as illustrated in (b) in FIG. 11 to (e) in FIG. 11, the searching unit 120 moves the two-dimensional information template 213, which is the search target, in the horizontal direction within the taken image. At that time, the searching unit 120 clips the two-dimensional information template 213 at the position of the boundary line 219, and obtains the degree of similarity with the image 411a using the clipped two-dimensional information template as the search target.

More particularly, in the state illustrated in (b) in FIG. 11, since the position of the two-dimensional information template 213 is not yet to reach the boundary line 219, the searching unit 120 obtains the degree of similarity using the two-dimensional information template 213 as it is. In the state in which some portion of the two-dimensional information template 213 is in contact with the boundary line 219 as illustrated in (c) in FIG. 11 and (d) in FIG. 11, the searching unit 120 discards portions 214a′ and 214b′ that are out of line from the boundary line 220, and obtains the degree of similarity using remaining portions 214a and 214b. Herein, the remaining portions 214a and 214b represent the difference between the two-dimensional information template which corresponds to the image 410 and whose position is already decided and the two-dimensional information template corresponding to the image 411.

In this example, in the state in which the two-dimensional information template 213 has moved to the position illustrated in (d) in FIG. 11, the portion 214b representing the remaining portion after clipping the two-dimensional information template 213 according to the boundary line 220 substantially matches with the image 411a, and the degree of similarity S becomes the highest. In that case, since the entire remaining portion 214b, which is obtained after clipping the two-dimensional information template 213, is similar to the image 411a; the degree of similarity becomes equal to 1.0, for example.

In the example given above, the highest degree of similarity=1.0) obtained during the search performed from the rear face is higher than the highest degree of similarity S (=0.4) obtained during the search performed from the front face. Hence, it can be determined that the two-dimensional information template 213 is present on the rear face side of the two-dimensional information template corresponding to the image 410. On the other hand, if the highest degree of similarity S obtained during the search performed from the front face is higher than the highest degree of similarity S obtained during the search performed from the rear face, it can be determined that the two-dimensional information template 213 is present on the front face side of the two-dimensional information template corresponding to the image 410.

During the search performed from the front face and the search performed from the rear face, when different degrees of similarity S are obtained at the same position within the taken image, the searching unit 120 can determine that the two-dimensional information template 213 and the dimensional information template corresponding to the image 410 are overlapping with each other. In the example explained above, since the two-dimensional information template 213 is moved, it is possible to think that such a two-dimensional information template is detected which has an overlapping portion with respect to the two-dimensional information template 213.

Meanwhile, in the example explained above, when the two-dimensional information template 213 corresponding to the image 411 is smaller in size than the two-dimensional information template corresponding to the image 410 and is present on the rear face side of the two-dimensional information template corresponding to the image 410; it is possible to think of a case in which, when viewed from the target vehicle 20, the two-dimensional information template 213 gets completely hidden behind the two-dimensional information template corresponding to the image 410. In that case, the searching unit 120 can use, for example, a two-dimensional information template 213′ having no contents (i.e., having only null data) (see (e) in FIG. 11) and performs a search at the position at which the two-dimensional information template 213 is hiding.

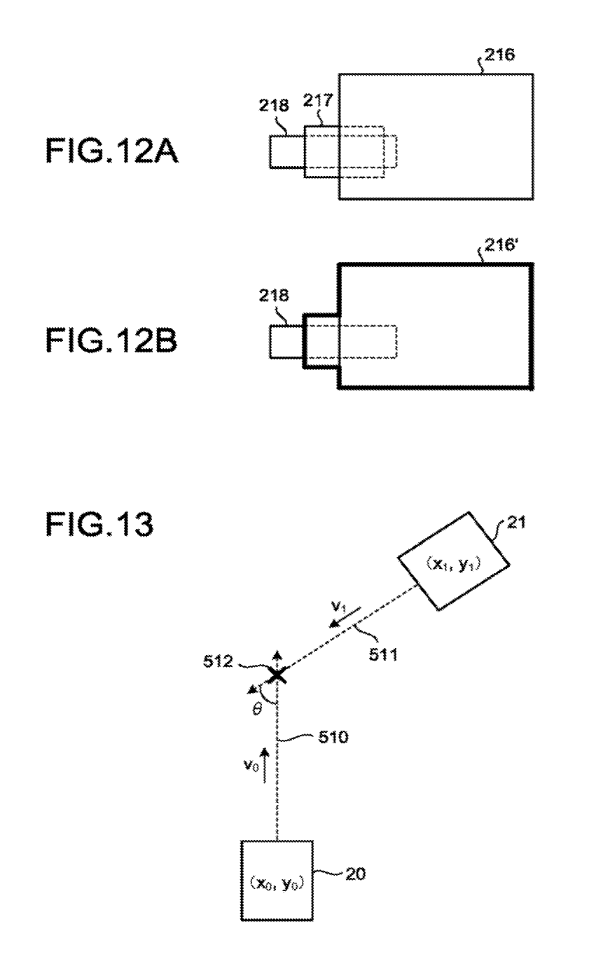

Meanwhile, as illustrated in FIG. 12A, in the state in which the positions of two mutually-overlapping two-dimensional information templates 216 and 217 are already decided within a taken image, it is also possible to perform a search using a subsequent two-dimensional information template 218. In this case, as illustrated in FIG. 12B, the searching unit 120 integrates the two-dimensional information templates 216 and 217, whose positions are already decided, and generates an integrated two-dimensional information template 216′; and performs a search with respect to the integrated two-dimensional information template 216′ using the two-dimensional information template 218.

Returning to the explanation with reference to FIG. 7, at Step S109, based on the result of the operations performed at Steps S107 and S108 described above, the searching unit 120 determines whether or not a pair of two-dimensional information templates having mutually overlapping portions is present. If it is determined that such a pair is not present (No at Step S109), it marks the end of the operations illustrated in the flowchart in FIG. 7.

On the other hand, if it is determined that a pair of two-dimensional information templates having mutually overlapping portions is present (Yes at Step S109), the system control proceeds to Step S110. At Step S110, the calculating unit 121 calculates the overlapping percentage of the two-dimensional information templates in the pair of two-dimensional information templates having mutually overlapping portions. When at least some portion on the front face side of a first two-dimensional information template is partially or entirely overlapped by a second two-dimensional information template, the overlapping percentage of the two-dimensional information templates represents the ratio of the overlapping portion of the second two-dimensional information template with respect to the entire first two-dimensional information template.

As an example, in (d) in FIG. 11, the two-dimensional information template 213 on the rear side is equivalent to the first two-dimensional information template. Moreover, of the two-dimensional information template corresponding to the image 410, the two-dimensional information template on the front side corresponding to the two-dimensional information template 213 is equivalent to the second two-dimensional information template. Thus, the overlapping percentage represents the ratio of the portion 214b′, which represents such a portion of the two-dimensional information template 213 which protrudes from the boundary line 220 toward the inside of the image 410 (i.e., such a portion of the two-dimensional information template 213 which overlaps with the image 410), with respect to the entire two-dimensional information template on the rear side. In the example illustrated in (d) in FIG. 11, the overlapping percentage is about 60%, for example.

Subsequently, at Step S111, the calculating unit 121 determines whether or not the calculated overlapping percentage exceeds a threshold value. If it is determined that the overlapping percentage is equal to or smaller than the threshold value (No at Step S111), then the system control proceeds to Step S114. On the other hand, if it is determined that the overlapping percentage exceeds the threshold value (Yes at Step S111), then the system control proceeds to Step S112.

At Step S112, the output unit 122 determines whether or not there is a possibility of a collision between the target vehicle 20 and the surrounding vehicle 21 that corresponds to the two-dimensional information template on the rear side from the pair of two-dimensional information templates having mutually overlapping portions. If it is determined that there is no possibility of a collision (No at Step S112), then the system control proceeds to Step S114.

On the other hand, if it is determined that there is a possibility of a collision (Yes at Step S112), then the system control proceeds to Step S113 and the output unit 122 outputs a notification indicating the possibility of a collision. After the output unit 122 outputs the notification, the system control proceeds to Step S114.

At Step S114, the output unit 122 determines whether or not the operations are completed with respect to all pairs of two-dimensional information templates that have mutually overlapping portions and that are determined to be present at Step S109. If it is determined that the operations are not yet completed for all pairs (No at Step 14), then the system control returns to Step S110 and the operations are performed with respect to the next pair.

If it is determined that the operations are completed for all pairs (Yes at Step S114), it marks the end of the operations illustrated in the flowchart in FIG. 7. In hat case, the operations illustrated in the flowchart in FIG. 7 are repeatedly performed from Step 2100 onward.

The operation for determining whether or not there is a possibility of a collision as performed at Step S112 according to the first embodiment is explained below with reference to FIG. 13. At Step S112, the output unit 122 obtains, from the surrounding-vehicle-information obtaining unit 112, the surrounding-vehicle information 140 of the surrounding vehicle 21 corresponding to the two-dimensional information template on the rear side from the pair of two-dimensional information templates having mutually overlapping portions. Moreover, the output unit 122 obtains the target-vehicle information 143 of the target vehicle 20 from the target-vehicle information obtaining unit 113

The output unit 122 retrieves the position information, the travelling direction information, and the velocity information of the surrounding vehicle 21 from the surrounding-vehicle information 140; and retrieves the position information, the travelling direction information, and the velocity information of the target vehicle 20 from the target-vehicle information 143. Herein, a position (x₀, y₀) represents the position of the target vehicle 20, an angle 0° represents the travelling direction of the target vehicle 20, and v₀ represents the velocity of the target vehicle 20. Similarly, a position (x₁, y₁) represents the position of the surrounding vehicle 21, an angle θ represents the travelling direction of the surrounding vehicle 21, and v₁ represents the velocity of the surrounding vehicle 21.

Based on the position (x₀, y₀), the angle 0°, and the velocity v₀ of the target vehicle 2C as well as based on the position (x₁, y₁) the angle θ, and the velocity v₁ of the surrounding vehicle 21, the output unit 122 can obtain a vector indicating the movement of the target vehicle 20 at the point of time of obtaining the target-vehicle information 143 and can obtain a vector indicating the movement of the surrounding vehicle 21 at the point of time of obtaining the surrounding-vehicle information 140.

When the target vehicle 20 travels in a direction 510 at the speed v₀ and when the surrounding vehicle 21 travels in a direction 511 at the speed v₁; the output unit 122 can calculate, based on the obtained vectors, the timings at which the target vehicle 20 and the surrounding vehicle 21 reach a spot 512 at which the directions 510 and 511 intersect. If the calculation result indicates that the target vehicle 20 and the surrounding vehicle 21 reach the spot 512 at the same timing or within a predetermined time period, then the output unit 122 can determine that there is a possibility of a collision.

### Specific Example of First Embodiment

Explained below with reference to the flowchart illustrated in FIG. 7 is a specific example of the first embodiment. Firstly, the explanation is given about a case in which the notification output at Step S113 is not performed.

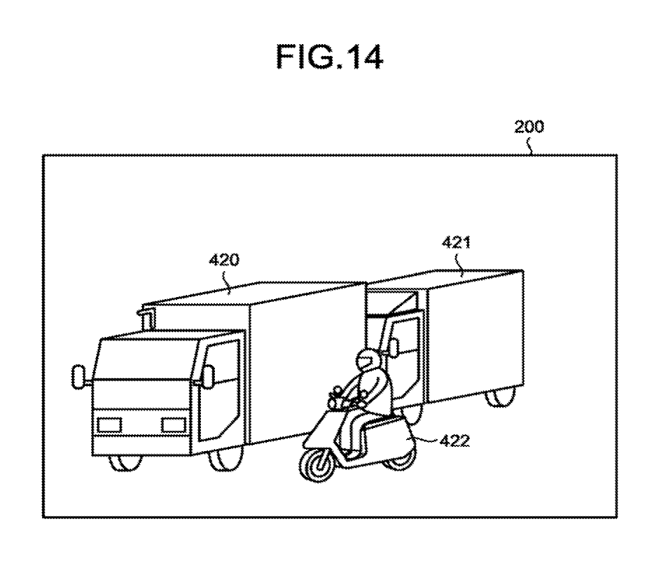

In FIG. 14 is illustrated an example of a taken image obtained by the imaging processing unit 117. Herein, for the purpose of illustration, it is assumed that the taken image is obtained immediately before performing Step S100 in flowchart illustrated in FIG.7. In the example illustrated in FIG. 14, in the taken image 200, three vehicles 420, 421, and 422 are captured that represent the surrounding vehicles 21 with respect to the target vehicle 20. Regarding the vehicles 420 to 422; with respect to the target vehicle 20, the vehicle 420 is positioned behind the vehicle 422, and the vehicle 421 is positioned behind the rear side of the vehicle 420 with reference to the direction of travel. In the case of such positional relationship, it is believed that the driver of the vehicle 422 is able to see the target vehicle 20.

The surrounding-vehicle-information obtaining unit 112 makes use of the communication performed by the inter-vehicle communicating unit 111, and obtains the surrounding-vehicle information 140 corresponding to each of the vehicles 420 to 422 (Step S100 illustrated in FIG. 7). Based on the identification information 141 specified in the surrounding-vehicle information 140 corresponding to each of the vehicles 420 to 422 as obtained by the surrounding-vehicle-information obtaining unit 112, the generating unit 114 obtains the 3D profile information of each of the vehicles 420 to 422 (Step 102 illustrated in FIG. 7). Moreover, based on the state information 142 specified in each set of the surrounding-vehicle information 140 and based on the target-vehicle information 143 obtained by the target-vehicle information obtaining unit 113, the generating unit 114 calculates the relative positions of the vehicles 420 to 422 with respect to the target vehicle 20 (Step S103 illustrated in FIG. 7); and then generates two-dimensional information templates of the vehicles 420 to 422 based on the calculation result and based on the 3D profile information of the vehicles 420 to 422.

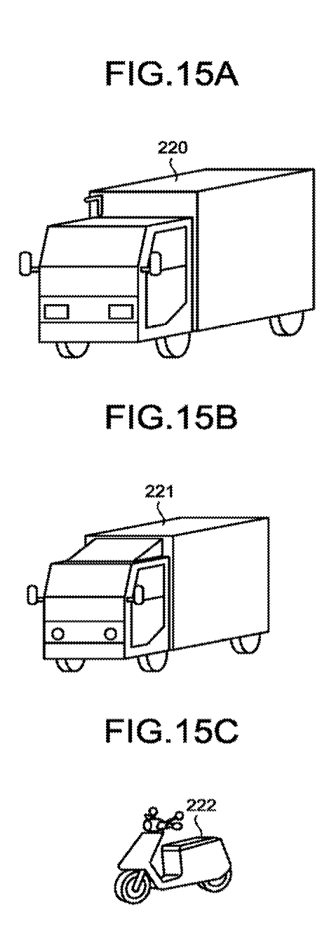

In FIG. 15 are illustrated examples of the two-dimensional information templates generated corresponding to the vehicles 420 to 422 by the generating unit 114 according to the first embodiment. In FIG. 15A is illustrated an example of a two-dimensional information template 220 corresponding to the vehicle 420. In FIG. 15B is illustrated an example of a two-dimensional information template 221 corresponding to the vehicle 421. In FIG. 15C is illustrated an example of a two-dimensional information template 222 corresponding to the vehicle 422.

The two-dimensional information templates 220 to 222 have the sizes in accordance with the sizes of the corresponding vehicles 420 to 422 and the relative positions with respect to the target vehicle 20. In the examples illustrated in FIG. 15A to FIG. 15C, of the two-dimensional information templates 220 to 222, it is assumed that the two-dimensional information template 220 is the largest in size and the two-dimensional information template 222 is the smallest in size.

The two-dimensional information templates 220 to 222 are associated to sets of the identification information 141 of the vehicles 420 to 422, respectively. Meanwhile, at the points at which the two-dimensional information templates 220 to 222 are generated, the images of the vehicles 420 to 422 in the taken image 200 are not associated to the two-dimensional information templates 220 to 222, respectively. Thus, the sets of the identification information 141 are also not associated to the images of the vehicles 420 to 422 in the taken image 200.

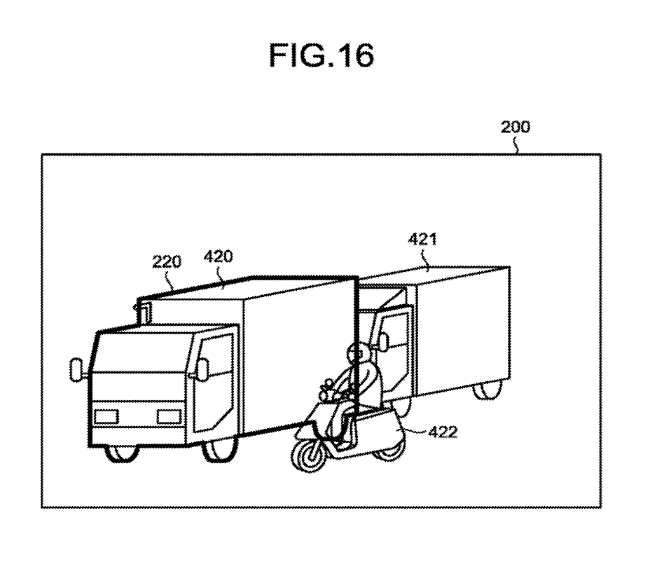

Explained below with reference to FIGS. 16 to 19 is a first example of the search operation performed at Steps S107 and sloe illustrated in FIG. 7 with respect to the two-dimensional information templates 220 to 222. During the initial search performed with respect to the taken image 200, the searching unit 120 performs a search with respect to the two-dimensional information template 220 having the largest size from among the two-dimensional information templates 220 to 222.

In FIG. 16 is illustrated a state in which the image of the vehicle 420 corresponding to the two-dimensional information template 220 is retrieved as a result of the search and the position of the two-dimensional information template 220 in the taken image 200 is decided. The searching unit 120 associates the identification information 141 corresponding to the two-dimensional information template 220 to the image of the vehicle 420 corresponding to the two-dimensional information template 220.

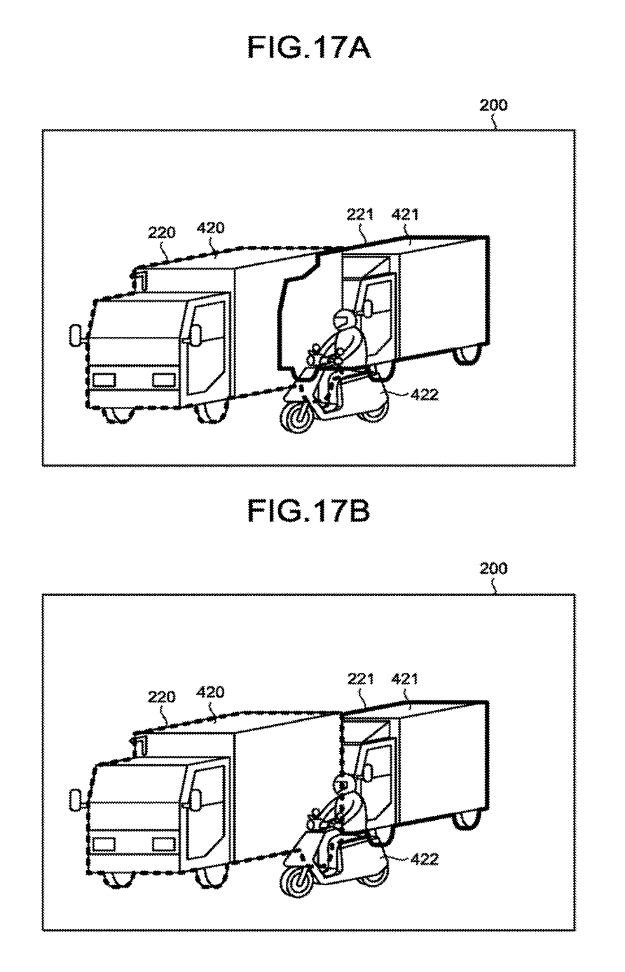

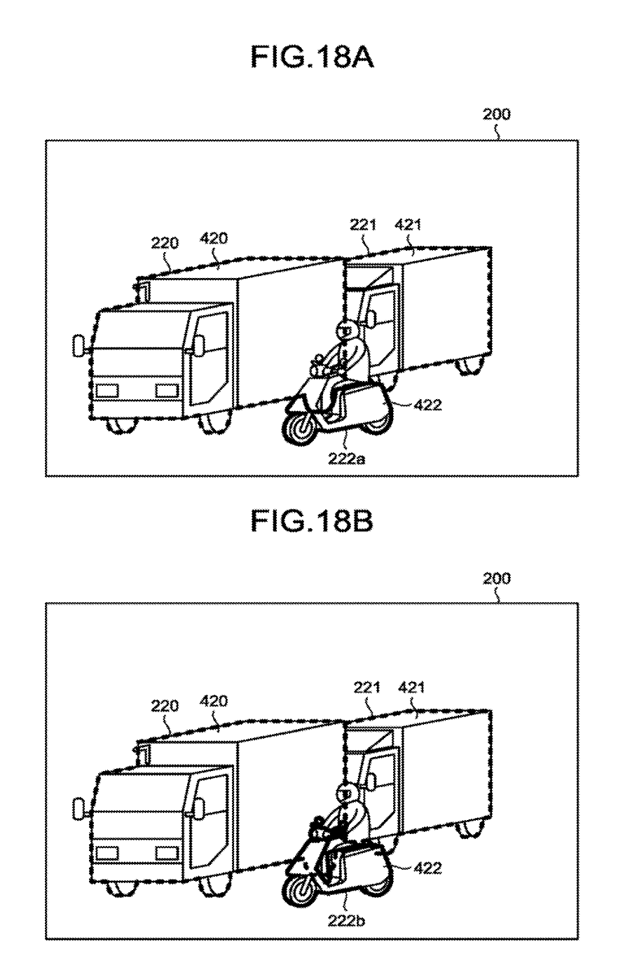

In FIG. 16 and in subsequent identical diagrams (i.e., in FIG. 17, FIG. 18, and FIGS. 21 to 23), a bold solid line represents the two-dimensional information template serving as the search target and a told dotted line represents the two-dimensional information template whose position is already defined in the search.

The searching unit 120 performs a search with respect to the two-dimensional information template 221 that is the largest after the two-dimensional information template 220 whose position has been decided. At that time, as described earlier, the searching unit 120 performs a search from the front face and from the rear face of the two-dimensional information template 220. In FIG. 17A is illustrated an example in which the search is performed from the front face of the two-dimensional information template 220, while in FIG. 17B is illustrated an example in which the search is performed from the rear face of the two-dimensional information template 220.

In this example, the vehicle 421 is positioned behind the vehicle 420 when viewed from the target vehicle 20, and the image of the vehicle 420 is overlapping with the image of the vehicle 421 in the taken image 200. Hence, the degree of similarity S becomes higher when a search is performed from the rear face (see FIG. 17B) as compared to a care in which a search is performed from the front face (see FIG. 17A). Thus, it can be understood that the two-dimensional information template 220 is overlapping with the two-dimensional information template 221, and the position of the two-dimensional information template 221 in the taker image 200 gets decided.

The searching unit 120 performs a search with respect to the two-dimensional information template 222 that is the largest after the two-dimensional information templates 220 and 221 whose positions have been decided. In that case too, in an identical manner to the explanation given above, regarding the two-dimensional information template 222, a search is performed from the front face and from the rear face of the two-dimensional information templates 220 and 221. In this case, for example, as explained with reference to FIG. 12, the search can be performed with respect to an integrated two-dimensional information template formed by integrating the two-dimensional information templates 220 and 221.

In FIG. 18A is illustrated an example in which a search is performed from the rear face of the integrated two-dimensional information template, and in FIG. 18B is illustrated an example in which a search is performed from the front face of the integrated two-dimensional information template. In the example illustrated in FIG. 18A, a portion 222a represents the difference of the two-dimensional information template 222 with respect to the integrated two-dimensional information template. In the example illustrated in FIG. 18B, the two-dimensional information template 222 is illustrated as it is as a two-dimensional information template 222b.

In this example, when viewed from the target vehicle 20, the vehicle 422 is positioned in front of the vehicles 420 and 421; and the image of the vehicle 422 is overlapping with the images of the vehicles 420 and 421 in the taken image 200. For that reason, the degree of similarity S becomes higher when a search is performed from the front face (see FIG. 18B) as compared to a case in which a search is performed from the rear face (see FIG. 18A). Thus, it can be understood that the two-dimensional information template 222 is overlapping with the integrated two-dimensional information template, and the position of the two-dimensional information template 222 in the taken image 200 gets decided.

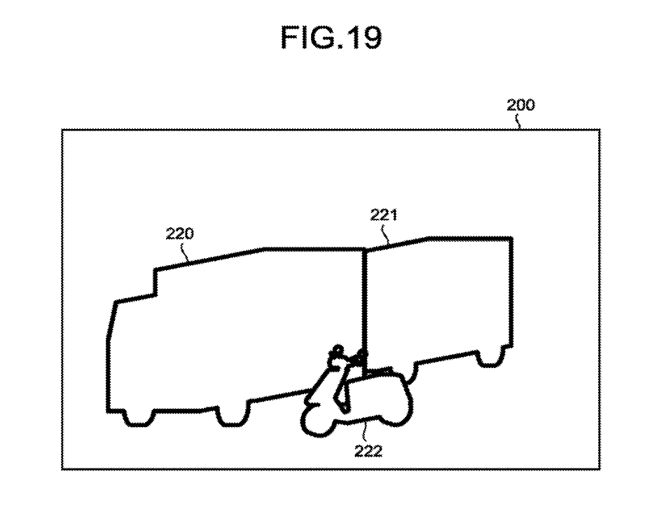

In FIG. 19 is schematically illustrated a state in which the positions of the two-dimensional information templates 220 to 222 in the taken image 200 are decided. In FIG. 19, in order to avoid complications, the two-dimensional information templates 220 to 222 are illustrated using only the frame border.

Based on the result of the search performed by the searching unit 120, the calculating unit 121 calculates the overlapping percentage of the two-dimensional information templates 220 to 222, and compares the overlapping percentage with a threshold value. Herein, the threshold value is set to 70%, for example.

In the example illustrated in FIG. 19, regarding the two-dimensional information templates 220 and 221, the two-dimensional information template 220 is overlapping with some portion on the front face of the two-dimensional information template 221, and the overlapping percentage is assumed to be 30%, for example. Moreover, regarding the two-dimensional information template 222, the two-dimensional information template 222 is overlapping with some portion on the front face of the integrated two-dimensional information template that is formed by integrating the two-dimensional information templates 220 and 221, and the overlapping percentage is assumed to be 5%, for example.

In the example illustrated in FIG. 19, either overlapping percentage is equal to or smaller than the threshold value. Thus, the operations at Steps S112 and S113 illustrated in FIG. 7 are skipped, and the output unit 122 does not output a notification.

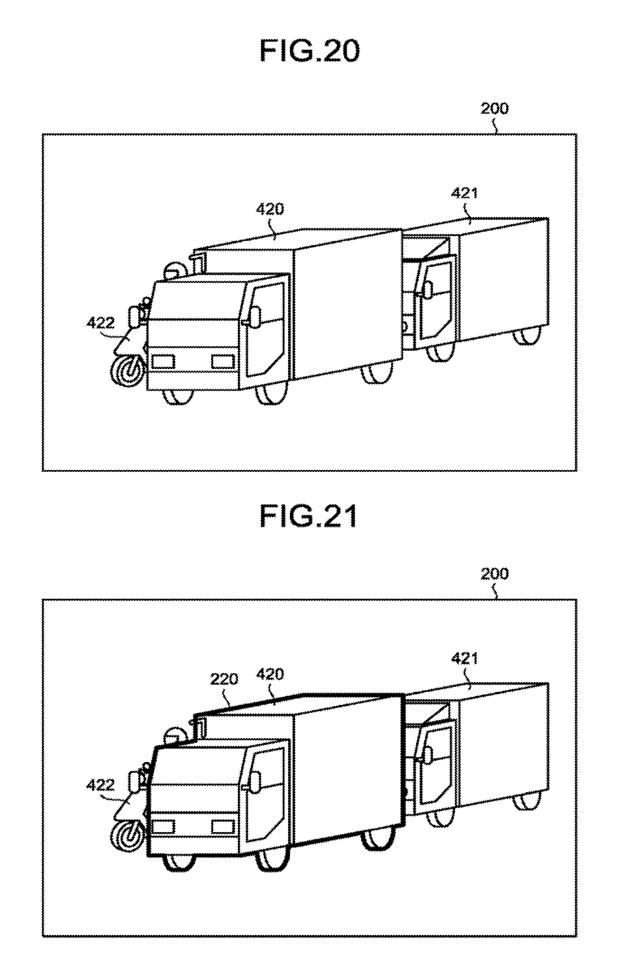

Given below is the explanation of an example in which a notification output at Step S113 in the flowchart illustrated in FIG. 7 is performed. In FIG. 20 is illustrated an exemplary taken image obtained by the imaging processing unit 117. In FIG. 20, the vehicles 420 to 422 are captured in the taken image 200 in an identical manner to FIG. 14. In the example illustrated in FIG. 20, regarding the vehicles 420 to 422, with respect to the target vehicle 20, the vehicle 422 is positioned behind the vehicle 420 with reference to a side in the direction of travel of the vehicle 420, and the vehicle 421 positioned behind the rear side of the vehicle 420 with reference to the direction of travel of the vehicle 420. In the case of such positional relationship, the driver of the vehicle 422 may not be able to see the target vehicle 20.

The operation by which the surrounding-vehicle-information obtaining unit 112 obtains the surrounding-vehicle information 140 is identical to the explanation given earlier, and the operation by which the generating unit 114 generates the two-dimensional information templates 220 to 222 corresponding to the vehicles 420 to 422, respectively, is identical to the explanation given earlier. Hence, that explanation is not repeated. Regarding the vehicles 420 to 422, the generating unit 114 is assumed to generate the two-dimensional information templates 220 to 222, respectively, illustrated in FIG. 15A to FIG. 15C.

Explained below with reference to FIGS. 21 to 24 is second example of the search operation performed with respect to the two-dimensional information templates 220 to 222 at Steps S107 and S108 illustrated in FIG. 7. During the initial search performed with respect to the taken image 200, the searching unit 120 performs a search with respect to the two-dimensional information template 220 having the largest size from among the two-dimensional information templates 220 to 222. In FIG. 21 is illustrated a state in which the image of the vehicle 420 corresponding to the two-dimensional information template 220 is retrieved as a result of the search and the position of the two-dimensional information template 220 in the taken image 200 is decided.

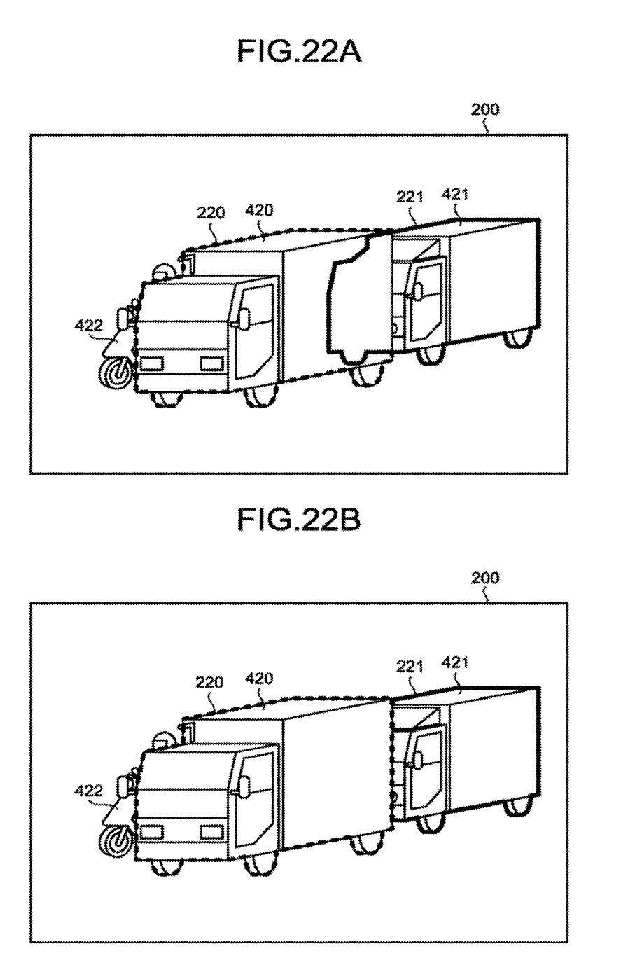

The searching unit 120 performs a search with respect to the two-dimensional information template 221, which is the largest after the two-dimensional information template 220 whose position has been decided, from the front side and from the rear side of the two-dimensional information template 20. In FIG. 22A is illustrated an example in which the search is performed from the front face of the two-dimensional information template 220, while in FIG. 22B is illustrated an example in which the search is performed from the rear face of the two-dimensional information template 220. In an identical manner to the examples illustrated in FIG. 17A and FIG. 17B, the two-dimensional information template 220 is overlapping with the two-dimensional information template and the position of the two-dimensional information template 221 in the taken image 200 gets decided.

Subsequently, the searching unit 120 performs a search with respect to the two-dimensional information template 222 that is the largest after the two-dimensional information templates 220 and 221 whose positions have been decided. In that case too, in an identical manner to the explanation given above, regarding the two-dimensional information template 222, a search is performed from the front face and from the rear face of the two-dimensional information templates 220 and 221.

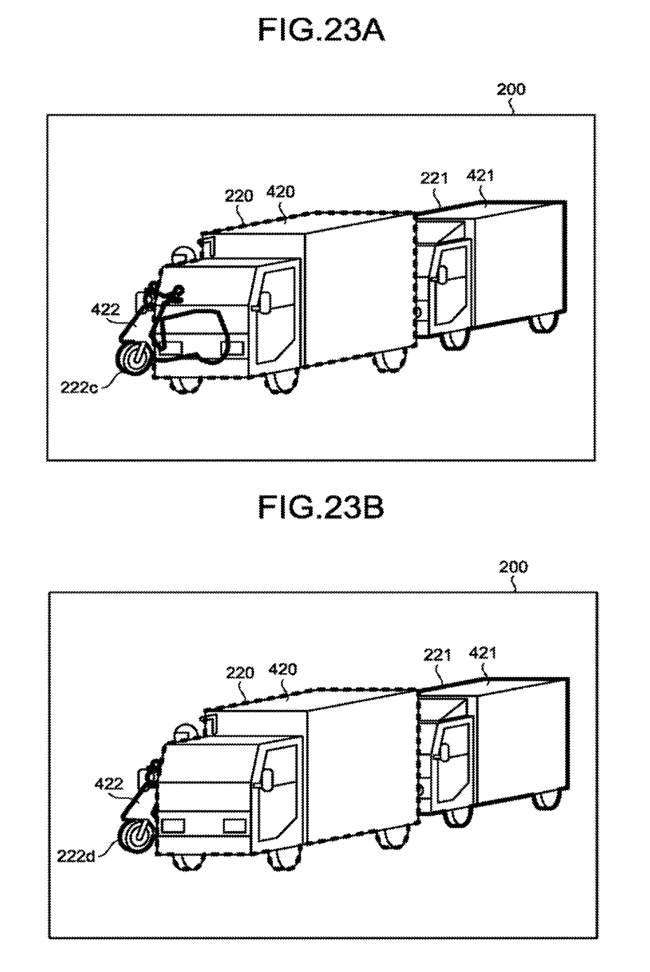

In FIG. 23A is illustrated an example in which a search is performed from the front face of the integrated two-dimensional information template that is formed by integrating the two-dimensional information templates 220 and 221, and in FIG. 23B is illustrated an example in which a search is performed from the rear face of the integrated two-dimensional information template. In the example illustrated in FIG. 23A, the two-dimensional information template 222 is illustrated as it is as a two-dimensional information template 222c. In the example illustrated in FIG. 23B, a portion 222d represents the difference of the two-dimensional information template 222 with respect to the integrated two-dimensional information template.

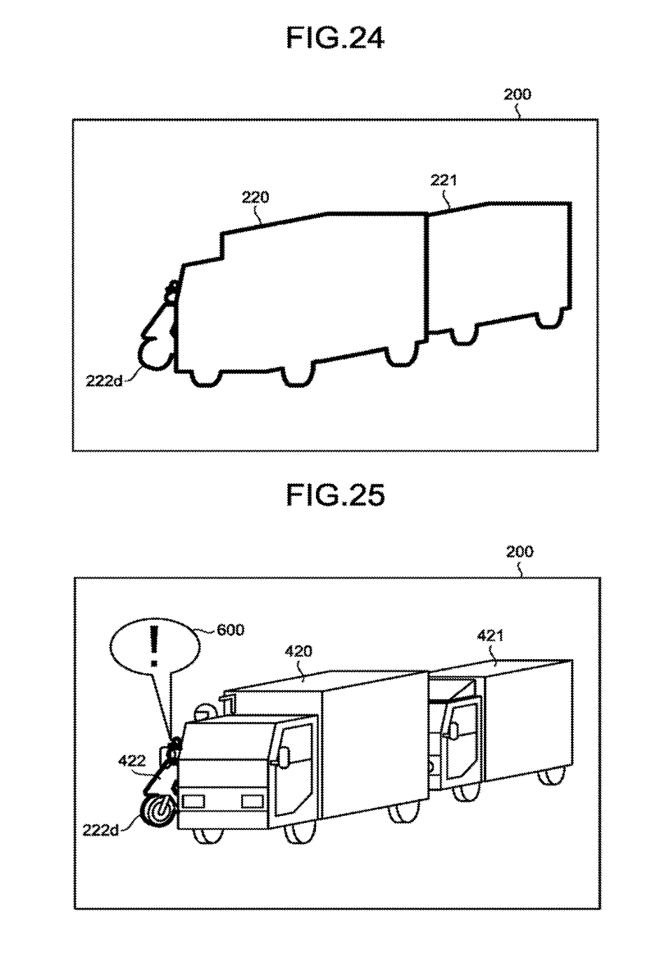

In this example, the vehicle 422 is positioned behind the vehicle 420 when viewed from the target vehicle 20, and the image of the vehicle 420 is overlapping with the image of the vehicle 422 in the taken image 200. Hence, the degree of similarity S becomes higher when a search is performed from the rear face (see FIG. 23B) as compared to a case in which a search is performed from the front face (see FIG. 23A). Thus, it can be understood that the integrated two-dimensional information template is overlapping with the two-dimensional information template 222, and the position of the two-dimensional information template 222 in the taker image 200 gets decided. In FIG. 24 is schematically illustrated a state in which the positions of the two-dimensional information templates 220 to 222 in the taken image 200 are decided.

Based on the result of the search performed by the searching unit 120, the calculating unit 121 calculates the overlapping percentage of the two-dimensional information templates 220 to 222, and compares the calculated overlapping percentage with a threshold value. In the example illustrated in FIG. 24, regarding the two-dimensional information templates 220 and 221, the two-dimensional information template 220 is overlapping with some portion on the front face of the two-dimensional information template 221, and the overlapping percentage is assumed to be 30%, for example. Regarding the two-dimensional information template 222, the integrated two-dimensional information template that is formed by integrating the two-dimensional information templates 220 and 222 is overlapping with some portion on the front face of the two-dimensional information template 222, and the overlapping percentage is assumed to be 80%, for example.

In the example illustrated in FIG. 24, since the overlapping percentage (=80%) with respect to the two-dimensional information template 222 exceeds the threshold value (=70%), the determination of a possibility of a collision is performed at Step S112 illustrated in FIG. 7.

Regarding the mutually-overlapping pair of the two-dimensional information template 222 and the integrated two-dimensional information template, the output unit 122 obtains the surrounding-vehicle information 140 of the vehicle 422, which corresponds to the two-dimensional information template 222 present on the rear face side, from the surrounding-vehicle-information obtaining unit 112. Moreover, the output unit 122 obtains the target-vehicle information 143 of the target vehicle 20 from the target-vehicle-information obtaining unit 113.

As explained with reference to FIG. 13, the output unit 122 determines whether or not there is a possibility of a collision between the target vehicle 20 and the vehicle 422 based on the position information, the travelling direction information, and the velocity information specified in the obtained surrounding-vehicle information 140 as well as in the target-vehicle information 143. If it is determined that there is a possibility of a collision, then the output unit 122 outputs a notification indicating the same.

In FIG. 25 is illustrated an exemplary display in response to a notification output by the output unit 122 according to the first embodiment. For example, the output unit 122 obtains the position information indicating the position of the two-dimensional information template 222, which corresponds to the vehicle 422 determined to be likely to collide with the target vehicle 20, in the taken image 200. Based on the obtained position information, the output unit 122 synthesizes a warning image 600, which indicates the possibility of a collision, with the taken image 200 at the position corresponding to the image of the vehicle 422 in the taken image 200; and then displays the taken image 200 on the display device 1008.

Moreover, in the example illustrated in FIG. 25, in addition to displaying the warning image 600, such a portion in the image of the vehicle 422 which is equivalent to the portion 222d, which represents the difference between the two-dimensional information template 222 of the vehicle 422 and the two-dimensional information template 220 of the vehicle 420, is displayed in a highlighted manner.

As described above, in the object detecting device 100 according to the first embodiment, two-dimensional information templates are generated by projecting 3D profile information onto a two-dimensional plane based on the following: the taken image 200, the surrounding-vehicle information 140 obtained using inter-vehicle communication, the 3D profile information of the surrounding vehicle 21, and the target-vehicle information 143 obtained from the target vehicle 20. Then, the object detecting device 100 performs a search in the taken image 200 using the two-dimensional information templates, and identifies the positions of the vehicles corresponding to the two-dimensional information templates. Hence, the surrounding vehicle 21 present around the target vehicle 20 can be detected with a high degree of accuracy.

Thus, as a result of using the object detecting device 100 according to the first embodiment, when the surrounding vehicles 21 come close with respect to the estimation accuracy of vehicle positions, vehicle detection becomes possible also for particularly such a surrounding vehicle 21 which is hidden behind a particular surrounding vehicle 21. Moreover, in case there is a possibility of a collision at intersection between the target vehicle 20 and a hidden surrounding vehicle 21 because of jumping out of the hidden surrounding vehicle 21 from behind a particular surrounding vehicle 21, it becomes possible to issue a warning.

### Second Embodiment

Given below is the explanation of a second embodiment. In the first embodiment, the explanation is given under the assumption that the target vehicle 20 has a single camera 1011 installed therein. In contrast, in the second embodiment, the explanation is given for an example in which the target vehicle is equipped with a plurality of cameras having mutually different imaging ranges.

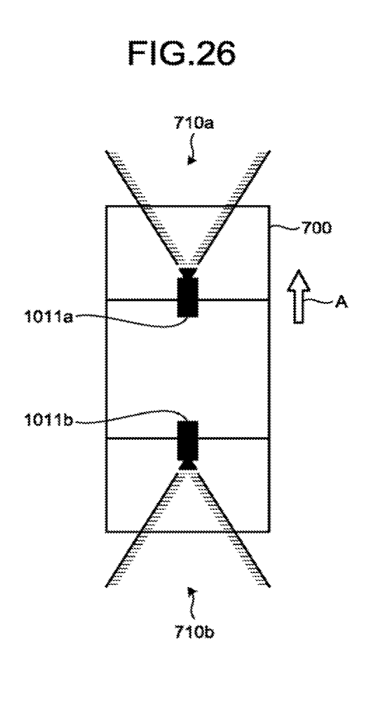

In FIG. 26 is illustrated an example of a target vehicle 700 in which two cameras 1011a and 1011b are installed. In this example, the two cameras 1011a and 1011b have mutually different imaging ranges 710a and 710b, respectively. In the target vehicle 700, when the direction indicated by an arrow A in FIG. 26 is the front direction, the camera 1011a captures the imaging range 710a on the front side and the camera 1011b captures the imaging range 710b on the rear side. Regarding which of the cameras 1011a and 1011b is to be used, the cameras can be switched manually or automatic switching can be set so as to alternately switch the cameras at predetermined intervals.

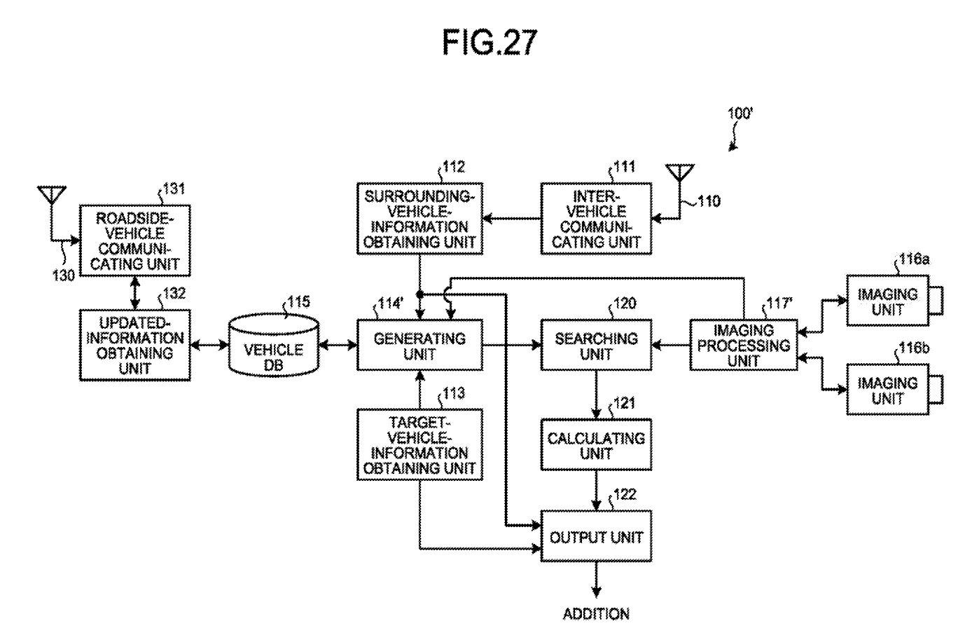

FIG. 27 is an exemplary functional block diagram for explaining the functions of an object detecting device 100′ according to the second embodiment. In FIG. 27, the portions identical to those illustrated in FIG. 2 are referred to by the same reference numerals, and the detailed explanation is not repeated.

With reference to FIG. 27, an imaging processing unit 117′ is capable of obtaining taken images from imaging units 116a and 116b that correspond to the cameras 1011a and 1011b, respectively. In response to a manual operation or automatic switching, the imaging processing unit 117′ can selectively output a taken image obtained from the imaging unit 116a or a taken image obtained from the imaging unit 116b. Moreover, the imaging processing unit 117′ outputs imaging unit selection information that indicates the currently-selected imaging unit from among the imaging units 116a and 116b. The imaging unit selection information is sent to a generating unit 114′.

While generating two-dimensional information templates, the generating unit 114′ selects surrounding-vehicle information from the sets of surrounding-vehicle information 140₁, 140₂, 140₃, and so on obtained by the surrounding vehicle information obtaining unit 112 according to the imaging unit selection information sent by the imaging processing unit 117′. Then, according to the selected surrounding-vehicle information, the generating unit 114′ generates a two-dimensional information template.

As an example, consider a case in which the imaging unit 116a is selected in the imaging processing unit 117′. In that case, of the sets of surrounding-vehicle information 140 obtained from the surrounding-vehicle-information obtaining unit 112 at Step S102 illustrated in FIG. 7, the generating unit 114′ selects the surrounding-vehicle information 140 in which the position information specified in the state information 142 corresponds to the imaging range 710a of the imaging unit 116a.

For example, it is assumed that, from among the sets of surrounding-vehicle information 140₁, 140₂, and 140₃, the position information specified in the surrounding-vehicle information 140₁ and 140₂ indicates the positions included in the imaging range 710a, while the position information specified in the surrounding-vehicle information 140₃ indicates the position included in the imaging range 710b.

When the imaging unit selection information indicates that the imaging unit 116a is selected, the generating unit 114′ generates two-dimensional information templates from among the sets of the surrounding-vehicle information 140₁, 140₂, and 140₃, based on the surrounding-vehicle information 140₁ and 140₂ in which the position information is included in the imaging range 710a. Moreover, when the imaging processing unit 117′ switches the imaging unit for use from the imaging unit 116a to the imaging unit 116b, the imaging unit selection information indicating the same is sent to the generating unit 114′. Then, according to the imaging unit selection information indicating that the imaging unit 116b is selected, the generating unit 114′ generates a two-dimensional information template based on the surrounding-vehicle information 140₃ in which the position information is included in the imaging range 710b from among the sets of surrounding-vehicle information 140₁, 140₂, and 140₃.

The explanation above is given for an example of using the two cameras 1011a and 1011b having mutually different imaging ranges. However, that is not the only possible case. That is, even if three or more vehicle-mounted cameras having mutually different imaging ranges are used, the second embodiment can be implemented in an identical manner.

### Other Embodiments

In the embodiments described above, a vehicle-mounted camera is used as the sensor for detecting the situation surrounding the target vehicle 20, and the determination of a possibility of a collision is performed using the taken image taken by the vehicle-mounted camera and the surrounding-vehicle information obtained using inter-vehicle communication. However, that is not the only possible case. As long as the sensor is capable of obtaining the situation surrounding the target vehicle in the form of two-dimensional information, it possible to use any type of sensor. For example, a laser radar that detects the surrounding situation using laser beams can be used as the sensor, or a millimeter-wave radar that detects the surrounding situation using millimeter waves can be used as the sensor. For example, a laser radar detects the presence of surrounding objects using point group data. If the point group data is used in place of taken images, it is possible to achieve the same effect as the effect explained earlier.

Moreover, in the explanation given above, it is written that the object detecting devices 100 and 100′ according to the embodiments support the driving of the driver. However, that is not the only possible case. Alternatively, for example, the object detecting devices 100 and 100′ according to the embodiments can also be implemented in examples in which a collision is avoided during autonomous running control of an automobile.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing front the spirit of the inventions. The accompanying claims and their equivalents are intended to cover such forms or modifications as would fall within the scope and spirit of the inventions.

What is claimed is:

1. An object detecting device comprising:
processing circuitry configured to;
obtain vehicle information at least containing identification information that enables identification of a surrounding vehicle around a target vehicle, first position information that indicates position of the surrounding vehicle, and first direction information that indicates direction of travel of the surrounding vehicle;
generate a two-dimensional information template based on profile information in form of three-dimensional vehicle information corresponding to the identification information, the first position information, the first direction information, second position information that indicates position of the target vehicle, and second direction information that indicates direction of travel of the target vehicle;
search for a position in two-dimensional information, which is obtained by a sensor for surroundings of the target vehicle, which corresponds to the two-dimensional information template;
when detecting a second template overlaps a first template based on a search result, calculate a ratio of overlapping portion between the second template and the first template with respect to an entire of the first template, the first template is the two-dimensional information template generated for a first surrounding vehicle, and the second template is the two-dimensional information template generated for a second surrounding vehicle; and
output a notification based on at least the ratio, the first position information, the first direction information, the second position information, and the second direction information.

2. The object detecting device according to claim 1, wherein the processing circuitry
searches for the position by obtaining a degree of similarity between the two-dimensional information template and the two-dimensional information while moving the two-dimensional information template within the two-dimensional information,
performs, when the second template is already retrieved,
a first search by ignoring the second template and moving the first template, and
a second search that is based on difference between the second template and the first template, and
determines, when the degree of similarity obtained in the second search is higher than the degree of similarity obtained in the first search, that the overlapping is detected.

3. The object detecting device according to claim 1, wherein the processing circuitry further
stores the profile information in a corresponding manner to the identification information; and
obtains update information for updating the profile information and the identification information.

4. The object detecting device according to claim 1, wherein, from among two or more of the two-dimensional information templates, the processing circuitry sequentially searches the position in order from the two-dimensional information template having largest size.

5. The object detecting device according to claim 1, wherein the processing circuitry generates the two-dimensional information template by further using range information that indicates a range within which the sensor is able to obtain the two-dimensional information.

6. The object detecting device according to claim 1, wherein the processing circuitry outputs the notification indicating a possibility of a collision between vehicle corresponding to the first position information and the target vehicle.

7. The object detecting device according to claim 6, wherein
the processing circuitry further
obtains first velocity information that indicates velocity of surrounding vehicles around the target vehicle, and
determines whether or not there is a possibility of the collision based on the ratio, the first position information, the first direction information, the first velocity information, the second position information, the second direction information, and second velocity information indicating velocity of the target vehicle.

8. An object detecting method comprising:
obtaining, vehicle information at least containing identification information that enables identification of a surrounding vehicle around a target vehicle, first position information that indicates position of the surrounding vehicle, and first direction information that indicates direction of travel of the surrounding vehicle;
generating a two-dimensional information template based on profile information in form of three-dimensional vehicle information corresponding to the identification information, the first position information, the first direction information, second position information that indicates position of the target vehicle, and second direction information that indicates direction of travel of the target vehicle;
searching for such a position in two-dimensional information, which is obtained by a sensor for surroundings of the target vehicle, which corresponds to the two-dimensional information template;
calculating, when the searching results in detection of which a second template overlaps a first template based on a search result, a ratio of overlapping portion between the second template and the first template with respect to an entire of the first template, the first template is the two-dimensional information template generated for a first surrounding vehicle, and the second template is the two-dimensional information template generated for a second surrounding vehicle; and
outputting a notification based on at least the ratio, the first position information, the first direction information, the second position information, and the second direction information.

9. The object detecting method according to claim 6, wherein the searching includes searching for the position by obtaining a degree of similarity between the two-dimensional information template and the two-dimensional information while moving the two-dimensional template information within the two-dimensional information,
performing, when the second template is already retrieved,
a first search that ignores the second template and moves the first template, and
a second search that is based on difference between the second template and the first template, and
determining, when the degree of similarity obtained in the second search is higher than the degree of similarity obtained in the first search, that the overlapping is detected.

10. The object detecting according to claim 8, further comprising:
storing the profile information in a corresponding manner to the identification information, wherein
the obtaining includes obtaining update information for updating the profile information and the identification information.

11. The object detecting method according to claim 8, wherein, from among two or more of the two-dimensional information templates, the searching includes sequentially searching the position in order from the two-dimensional information template having largest size.

12. The object detecting method according to claim 5 wherein the generating includes generating the two-dimensional information template by farther using range information that indicates a range within which the sensor is able to obtain the two-dimensional information.

13. The object detecting method according to wherein the outputting includes outputting the notification indicating a possibility of a collision between vehicle corresponding to the first position information and the target vehicle.

14. The object detecting method according to claim 13, wherein
the obtaining includes obtaining first velocity information that indicates velocity of surrounding vehicles around the target vehicle, and
the outputting includes determining whether or not there is a possibility of the collision based on the ratio, the first position information, the first direction information, the first velocity information, the second position information, the second direction information, and second velocity information indicating velocity of the target vehicle.

15. A computer program product having a non-transitory computer readable medium including an object detecting program, wherein the object detecting program, when executed by a computer, causes the computer to perform:
obtaining, vehicle information at least containing identification information that enables identification of surrounding vehicle around a target vehicle, first position information that indicates position of the surrounding vehicle, and first direction information that indicates direction of travel of the surrounding vehicle;
generating a two-dimensional information template based on profile information in form of three-dimensional vehicle information corresponding the identification information, the first position information, the first direction information, second position information that indicates position of the target vehicle, and second direction information that indicates direction of travel of the target vehicle;
searching for such a position in two-dimensional information, which is obtained by a sensor for surroundings of the target vehicle, which corresponds to the two-dimensional information template;
calculating, when the searching results in detection of which a second template overlaps a first template based on a search result, a ratio of overlapping portion between the second template and the first template with respect to an entire of the first template, the first template is the two-dimensional information template generated for a first surrounding vehicle, and the second template is the two-dimensional information template generated for a second surrounding vehicle; and
outputting a notification based on at least the ratio, the first position information, the first direction information, the second position information, and the second direction information.

16. The computer program product according to claim 15, wherein the searching includes searching for the position by obtaining a degree of similarity between the two-dimensional information template and the two-dimensional information while moving the two-dimensional template information within the two-dimensional information,
performing, when the second template is already retrieved,
a first search that ignores the second template and moves the first template, and
a second search that is based on difference between the second template and the first template, and
determining, when the degree of similarity obtained in the second search is higher than the degree of similarity obtained in the first search, that the overlapping is detected.

17. The computer program product according to claim 15, further comprising:
storing the profile information in a corresponding manner to the identification information, whereto
the obtaining includes obtaining update information for updating the profile information and the identification information.

18. The computer program product according to claim 15, wherein, from among two or more of the two-dimensional information templates, the searching includes sequentially searching the position in order from the two-dimensional information template having largest size.

19. The computer program product according to claim 15, wherein the generating includes generating the two-dimensional information template by further using range information that indicates a range within which the sensor is able to obtain the two-dimensional information.

20. The computer program product according to claim 15, wherein the outputting includes outputting the notification indicating a possibility of a collision between vehicle corresponding to the first position information and the target vehicle.
